(19) United States
(12) Patent Application Publication
(10) Pub. No.: US 2025/0280220 A1
(43) Pub. Date: Sep. 4, 2025

(54) HEADPHONES AND CARRYING CASE

(71) Applicant: SONY GROUP CORPORATION, TOKYO (JP)

(72) Inventors: YUSHI KOYAMA, TOKYO (JP); TOMOKI KYOIZUMI, TOKYO (JP); TOSHIHIKO NAKAJIMA, TOKYO (JP); TOMOMASA YOKOYAMA, TOKYO (JP); KAZUHIRO NISHIDA, TOKYO (JP)

(21) Appl. No.: 18/857,904

(22) PCT Filed: Mar. 9, 2023
(86) PCT No.: PCT/JP2023/009161

§ 371 Date: Oct. 18, 2024

(30) Foreign Application Priority Data
Apr. 26, 2022 (JP) 2022-072711

(51) Int. Cl. H04R 1/10; A45C 11/00; H04R 1/08

(52) U.S. Cl. CPC H04R 1/1008; A45C 11/001; H04R 1/083; H04R 1/105; H04R 1/1066; H04R 1/1091; H04R 2201/107; H04R 2460/01

(57) ABSTRACT

To provide headphones with an improved noise canceling function and the like.

Headphones include a headband, a housing, an ear pad attached to the housing, a hanger that supports the housing, and a slider that connects the hanger to an end portion of the headband. The headphones further include a microphone arranged at a place of the housing outside a movable range of the hanger. The housing includes a case that covers a movable range of the hanger. The hanger and the microphone are arranged in the same space formed in the housing on an outer peripheral side of the hanger.

### TECHNICAL FIELD

A technology disclosed in the present specification (hereinafter referred to as “present disclosure”) relates to headphones and a carrying case for headphones.

### BACKGROUND ART

Headphones are widely known as acoustic equipment combining devices that convert an electrical signal output from a reproduction device or a receiver into sound waves (audible sound) using a sounding body (speaker or the like) close to the ear (eardrum). Recently, with the spread of compact and high-performance reproduction devices, the use of headphones is also increasing.

Headphones are often used outdoors, on the road, on a moving train, or the like, and noise resistance is strongly desired. Therefore, high-performance and high-definition headphones (see Patent Document 1, for example) having a noise canceling function that cancels noise in an external environment and provides the listener with a good music reproduction environment have been developed and are already used.

In addition, in order to facilitate carrying of the headphones and to store the headphones and preventing damage due to external force at the time of storage, a carrying case for the headphones has also been developed (see Patent Document 2, for example), and is often supplied together with the headphones or separately.

In addition, the pad portion of the headphones that comes into contact with the ear is made of a material such as polyurethane excellent in cushioning property, but there is a problem that the pad portion is hydrolyzed under the influence of perspiration and body temperature to deteriorate over time.

For this reason, there are cases where the ear pad is replaceable (see Patent Document 3, for example), and a replacement pad at the time of deterioration is commercially available. In addition, headphones including an ear pad having no air permeability in consideration of sound insulation have been proposed (see Patent Document 4, for example).

### CITATION LIST

### Patent Document

Patent Document 1: Japanese Patent Application Laid-Open No. 2008-116782
Patent Document 2: Japanese Patent Application Laid-Open No. 2013-38671
Patent Document 3: Japanese Patent Application Laid-Open No. 2010-187151
Patent Document 4: Japanese Patent Application Laid-Open No. 2021-164085
Patent Document 5: Japanese Patent Application Laid-Open No. 2010-62733
Patent Document 6: Japanese Patent Application Laid-Open No. 2006-344813

### SUMMARY OF THE INVENTION

### Problems to be Solved by the Invention

An object of the present disclosure is to provide headphones and a carrying case for headphones with an improved noise canceling function and the like.

### Solutions to Problems

The present disclosure has been made in view of the above problems, and a first aspect thereof is headphones including
a headband, a housing, an ear pad attached to the housing, a hanger that supports the housing, and a slider that connects the hanger to an end portion of the headband, in which
the headphones further include a microphone arranged at a place of the housing outside a movable range of the hanger.

The housing includes a case that covers a movable range of the hanger, and has a slit for operating a joint portion of the hanger with the head band. Moreover, the hanger and the microphone are arranged in the same space formed in the housing. For example, the microphone is arranged on an outer peripheral side of the hanger.

Moreover, the slider has a seamless short-arc hollow pipe shape, and contains a cable connected to a circuit in the housing in the hollow pipe. Specifically, the slider includes a resin having a seamless short-arc hollow pipe shape and a shaft twist slider including a metal nut component inserted in a joint portion between the resin and the hanger, and the slider rotatably supports the hanger about a center line of the slider by a fastening structure between the metal nut component and a distal end of a shaft twist inserted into the hanger.

Furthermore, the ear pad is configured by containing a ring-shaped urethane foam in a skin, and the skin is configured by bonding a thin urethane film integrated with at least one of a bottom surface or a front surface of a wet foam layer having a three-dimensional microporous structure to a base cloth. Alternatively, the ear pad is configured by containing a ring-shaped urethane foam in a skin, and the skin is configured by bonding a wet foam layer having a three-dimensional microporous structure to a front surface of a product obtained by bonding an air-impermeable moisture-permeable waterproof film to any one of a bottom surface and a front surface of a wet base cloth having open cells or air permeability.

In addition, the ear pad includes a fixing claw including a finger hook portion provided on the inner peripheral side of the ring shape. The fixing claw has a claw fitting structure with a claw fixing portion on the housing side. The ear pad includes fixing claws arranged at a plurality of locations on an inner periphery. The fixing claws arranged at a plurality of locations include a fixing claw including a finger hook portion and a fixing claw not including a finger hook portion. The fixing claws including a finger hook portion are arranged side by side in a range where a curvature radius R of the ear pad is small at the front of the face of the wearer.

In addition, a wiring portion including a hole for inserting a wire rod is provided in a wall separating a space in the housing, and acoustic sealing of the space in the housing is achieved by inserting a bushing into the hole so as to press the wire rod against a wall surface of the hole. The bushing has a rib formed over the entire circumference, and the rib interferes with a wall surface of the hole when the bushing is inserted into the hole.

Furthermore, a second aspect of the present disclosure is a carrying case for the headphones mainly according to the first aspect of the present disclosure, including:
a top surface lid portion;
a bottom surface tray portion; and
a side surface portion having a ring shape sewn to the top surface lid portion and the bottom surface tray portion and having a fold that is folded by a pressing force in a vertical direction.

### Effects of the Invention

According to the present disclosure, it is possible to provide headphones and a carrying case for headphones with an improved noise canceling function and the like.

Note that the effects described in the present specification are merely examples, and the effects brought by the present disclosure are not limited thereto. Furthermore, the present disclosure may further provide additional effects in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a diagram illustrating the appearance of headphones 100.

FIG. 2 is a diagram illustrating the appearance (state in which slide function is used) of the headphones 100.

FIG. 3 is a diagram illustrating a functional configuration of a noise canceling system.

FIG. 4 is a four-view diagram of the headphones 100 according to an embodiment of the present disclosure.

FIG. 5 is a perspective view of a housing 101.

FIG. 6 is a cross-sectional view of the housing 101 taken along line A-A of FIG. 4.

FIG. 7 is a side view and a cross-sectional view of the housing 101 (when tilt angle of hanger 103 is minimum).

FIG. 8 is a side view and a cross-sectional view of the housing 101 (when tilt angle of hanger 103 is maximum).

FIG. 9 is a diagram illustrating an arrangement example of microphones in a case where the hanger 103 is Y-shaped and has two movable shafts.

FIG. 10 is a diagram illustrating an arrangement example of microphones in a case where the hanger 103 has one movable shaft.

FIG. 11 is a diagram illustrating an arrangement example of microphones in a case where the hanger 103 has one movable shaft.

FIG. 12 is a diagram collectively illustrating microphone arrangement examples of a plurality of patterns.

FIG. 13 is a diagram illustrating an arrangement example in which four microphones are arranged separately in a first floor portion and a second floor portion of the housing 101.

FIG. 14 is an enlarged view of a joint portion between a slider 104 and a hanger 103 in the headphones 100 according to the present disclosure.

FIG. 15 is a diagram illustrating a cross section of a joint portion between the slider 104 and the hanger 103.

FIG. 16 is a diagram illustrating the vicinity of the lower end of the slider 104 into which a shaft twist slider 1503 is inserted.

FIG. 17 is a perspective view of the slider 104.

FIG. 18 is a side view of the slider 104.

FIG. 19 is a cross-sectional view of the slider 104.

FIG. 20 is an enlarged view of a joint portion between the slider 104 and the hanger 103.

FIG. 21 is a diagram illustrating a state in which air flows around the vicinity of the joint portion between the slider 104 and the hanger 103.

FIG. 22 is a plan view of 22 an ear pad 107.

FIG. 23 is a cross-sectional view of the ear pad 107 taken along line B-B.

FIG. 24(A) is a diagram illustrating a cross-sectional structure of a normal wet synthetic leather, and FIG. 24(B) is a diagram illustrating a cross-sectional structure of a normal dry synthetic leather.

FIG. 25 is a diagram illustrating a cross-sectional structure of an example of synthetic leather used for a skin containing urethane foam.

FIG. 26 is a diagram illustrating a modification of the synthetic leather illustrated in FIG. 25.

FIG. 27 is a diagram illustrating another modification of the synthetic leather illustrated in FIG. 25.

FIG. 28 is a diagram illustrating a cross-sectional structure of another example of synthetic leather used for a skin containing urethane foam.

FIG. 29 is a diagram illustrating a modification of the synthetic leather illustrated in FIG. 28.

FIG. 30 is a diagram illustrating a cross-sectional structure of yet another example of synthetic leather used for a skin containing urethane foam.

FIG. 31 is a diagram illustrating a modification of the synthetic leather illustrated in FIG. 30.

FIG. 32 is a diagram illustrating a cross-sectional structure of still another example of synthetic leather used for a skin containing urethane foam.

FIG. 33 is a diagram illustrating a modification of the synthetic leather illustrated in FIG. 32.

FIG. 34 is a diagram illustrating a cross-sectional view of the ear pad 107 and the housing 101.

FIG. 35 is a further enlarged view of a fixing claw on the ear pad 107 side and a claw fixing portion on the housing 101 side in the cross-sectional view illustrated in FIG. 34.

FIG. 36 is a diagram illustrating an example in which six claw fitting structures are arranged in the ear pad 107 and the housing 101.

FIG. 37 is a perspective view illustrating arrangement places of two fixing claws arranged side by side in a range where R is small.

FIG. 38 is a diagram illustrating a state in which a finger is inserted into one of the two fixing claws illustrated in FIG. 37 to remove the fixing claw.

FIG. 39 is a diagram illustrating a state in which an ear (auricle) is inserted into an elliptical shape of the ear pad 107.

FIG. 40 is a diagram illustrating a modification of the finger hook portion of the fixing claw.

FIG. 41 is a diagram illustrating another modification of the finger hook portion of the fixing claw.

FIG. 42 is a diagram illustrating another example in which the plurality of claw fixing portions is arranged.

FIG. 43 is a diagram illustrating a state in which a cushion material is wrapped around a wire rod.

FIG. 44 is a diagram illustrating an external configuration example of a bushing 4400.

FIG. 45 is a diagram illustrating a state (cross-sectional view) in which the bushing 4400 is inserted into a component 4500 forming a hole.

FIG. 46 is a diagram illustrating a state (cross-sectional view) in which the bushing 4400 is inserted into the component 4500 forming the hole.

FIG. 47 is a diagram illustrating an influence of attachment of the bushing 4400 on frequency characteristics of the headphones 100.

FIG. 48 is a diagram illustrating a modification of the arrangement place of the wiring portion (or place where bushing is applied) in the case of the housing 101.

FIG. 49 is a diagram illustrating another modification of the arrangement place of the wiring portion (or place where bushing is applied) in the housing 101.

FIG. 50 is a six-view diagram of the appearance of a carrying case 5000 as viewed from upper, lower, front, rear, left, and right sides.

FIG. 51 is a two-view diagram in which the carrying case 5000 is opened as viewed from the upper side and from one side surface.

FIG. 52 is an exploded view of the carrying case 5000 disassembled into its main components.

FIG. 53 is a diagram illustrating a developed view of an upper gusset portion 5021 and a lower gusset portion 5022.

FIG. 54 is a diagram illustrating a state in which a side surface portion of the carrying case 5000 is folded.

FIG. 55 is a diagram illustrating a part where a fold is formed on a side surface portion of the carrying case 5000.

FIG. 56 is a diagram illustrating a part where a fold is formed on a side surface portion of the carrying case 5000.

FIG. 57 is an enlarged view of the vicinity of the upper end of the hanger 103.

FIG. 58 is a diagram illustrating the vicinity of the lower end of the slider 104 into which a shaft twist slider 1503 is inserted.

FIG. 59 is a diagram illustrating a basic structure of headphones.

FIG. 60 is a diagram illustrating a state in which a step is generated between a slider and a hanger when the hanger is twisted.

### MODE FOR CARRYING OUT THE INVENTION

Hereinafter, the present disclosure will be described in the following order with reference to the drawings.

A. Basic structure of headphones

B. Noise canceling function

C. Optimal arrangement of noise canceling microphones

D. Slider structure

E. Ear pad structure

E-1. Moisture permeable synthetic leather ear pad structure

E-2. Replaceable claw ear pad

F. Wiring portion sealing structure

G. Carrying case

### A. Basic Structure of Headphones

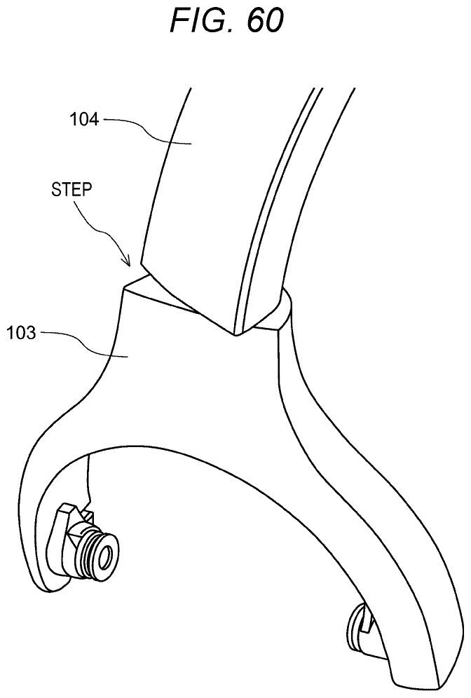

First, a basic structure of headphones will be described with reference to FIG. 59. Note, however, that FIG. 59 is merely used for convenience to describe basic components of headphones for reference, and the present disclosure is not limited thereto.

The illustrated headphones 5900 are a so-called overhead type, and include a pair of left and right housings 101, a headband 102 that clips the pair of left and right housings 101 to the head of the wearer (not illustrated), and a pair of left and right hangers 103 that couple the pair of left and right housings 101 with left and right end portions of the headband 102. The pair of left and right hangers 103 are fixed to left and right end portions of the headband 102 via sliders 104, respectively.

A speaker 106 and an ear pad 107 are arranged in each of the pair of left and right housings 101. The speaker 106 includes a sounding body such as a diaphragm (described later). A surface of the housing 101 from which the sound from the speaker 106 is output is also referred to as an “acoustic surface” for convenience. The acoustic surface is basically a side surface facing the ear of the wearer in the worn state. The ear pad 107 is attached to the acoustic surface and forms a noise canceling (NC) region in which its sound insulation property is secured. In the case of the housing 101, a printed wiring board on which electric components including a drive circuit of the speaker 106 are mounted is incorporated.

The headband 102 is curved in an arc shape and provided with elasticity, and is clipped to the head using the elastic force to press the pair of left and right housings 101 against the left and right ears of the wearer and hold the headphones 5900 on the head of the wearer. Note that the headband 102 may have a shape in which the curvature of the arc is curved gently to soften the feeling of pressing to the ear.

The lower end of a slider 104 is coupled to the upper end of the hanger 103. The method for coupling the slider 104 and the hanger 103 is not particularly limited (method for coupling slider 104 and hanger in present disclosure will be described later). Additionally, the upper end of the slider 104 is inserted into the headband 102 from an end portion of the hollow headband 102, and is attached so as to be stretchable in an extending direction of the headband 102 indicated by reference numeral 112. Therefore, by sliding the slider 104 in the extending direction 112 of the headband 102, the length of the slider 104 can be adjusted to fit the individual wearer's head size such that the housing 101 (acoustic surface on which speaker 106 is located) is just at the position of the ear.

Moreover, the hanger 103 is attached via the slider 104 so as to be rotatable about a center line 111 in an extending direction 112 of the headband 102 as a rotation axis. In short, the slider 104 has a slide function of sliding the position of the hanger 103 in the extending direction 112 and also a twist function of rotating the hanger 103 about the center line 111. Therefore, in a state where the headphones 5900 are worn on the head of the wearer, the hanger 103 rotates about the center line 111 of the headband 102, and the acoustic surface of the housing 101 has a rotation angle just following the shape of the temporal region of the wearer's head (or inclination of ear).

The hanger 103 is formed in a Y shape. The upper end of the hanger 103 is attached to the lower end of the head band 102 via the slider 104. Additionally, the housing 101 is attached to the bifurcated lower end of the hanger 103. Here, the housing 101 is supported by the hanger 103 so as to be rotatable about a broken line 113 connecting the bifurcated lower ends of the hanger 103 as a rotation axis. Therefore, in a state where the headphones 5900 are worn on the head of the wearer, the housing rotates about the rotation axis 113, and the acoustic surface of the housing 101 has a tilt angle just following the shape of the temporal region (or inclination of ear) different for each wearer.

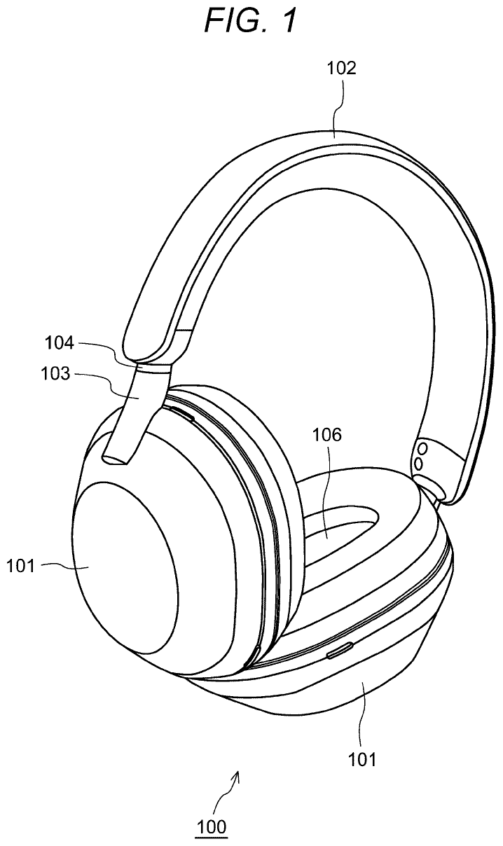

FIG. 1 illustrates the appearance of headphones 100 according to the best embodiment to which the present disclosure is applied. Similarly to the headphones 5900 exemplified for reference in FIG. 59, the headphones 100 include a pair of left and right housings 101 for holding speakers 106, a headband 102 that clips the pair of left and right housings 101 to the head of the wearer (not illustrated), and a pair of left and right hangers 103 that couple the pair of left and right housings 101 with left and right end portions of the headband 102. The pair of left and right hangers 103 are fixed to the left and right end portions of the headband 102 via sliders 104 that stretch and contract in the longitudinal direction.

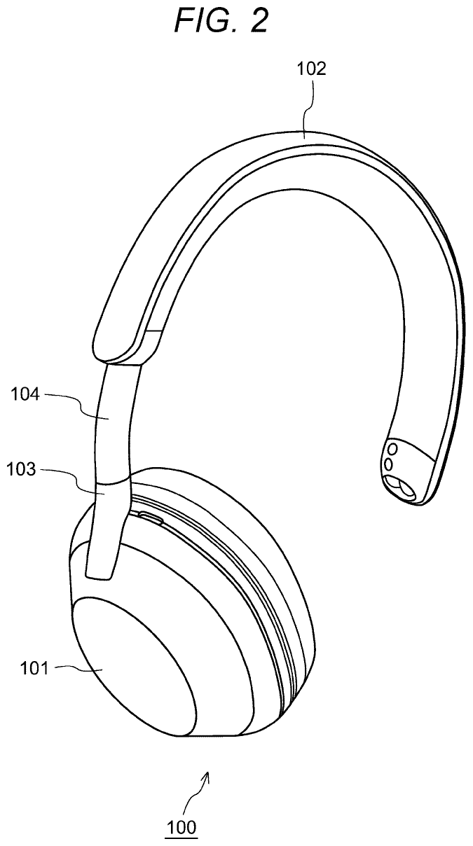

The headphones 100 illustrated in FIG. 1 are the same in that the headband 102 has a function of being clipped to the head using elastic force to wear the headphones 100 on the head of the wearer, the slider 104 has a slide function of sliding the position of the hanger 103 and a twist function of rotating the hanger 103 about the center line of the slider 104, and the hanger 103 has a function of adjusting the tilt angle of the housing 101. For reference, FIG. 2 illustrates a state in which the hanger 103 is extended from the end portion of the headband 102 by the slide function of the slider 104 on the near side (note, however, that illustration of the other housing 101 and hanger 103 is omitted).

The headphones 100 have many differences from the headphones 5900 illustrated in FIG. 59, such as that the slider 104 has a cylindrical shape and that the hanger 103 (at least bifurcated portion of Y shape and rotation shaft portion supporting housing 101) is arranged in the case of the housing 101, but main differences serving as features of the present disclosure will be described later.

### B. Noise Canceling Function

In order to enjoy music without being disturbed by external sound, high performance and high quality headphones having a noise canceling function have been developed and are already used. Noise canceling is generally achieved by a combination of passive noise canceling and active noise canceling. Passive noise canceling is achieved by maintaining the sound insulation property of a noise canceling (NC) region with an ear pad or the like. On the other hand, active noise canceling is a technology of canceling the low range to the middle range of external sound by generating a sound having an opposite phase to the external sound to cancel the external sound.

Active noise canceling includes a “feedforward method” that cancels an external sound in an NC region using a signal having an opposite phase to a signal picked up by a microphone (hereinafter also referred to as “feedforward (FF) microphone”) installed outside the NC region, and a “feedback method” that cancels an external sound in the NC region using a signal having an opposite phase to a signal picked up by a microphone (hereinafter also referred to as “feedback (FB) microphone”) installed in the NC region.

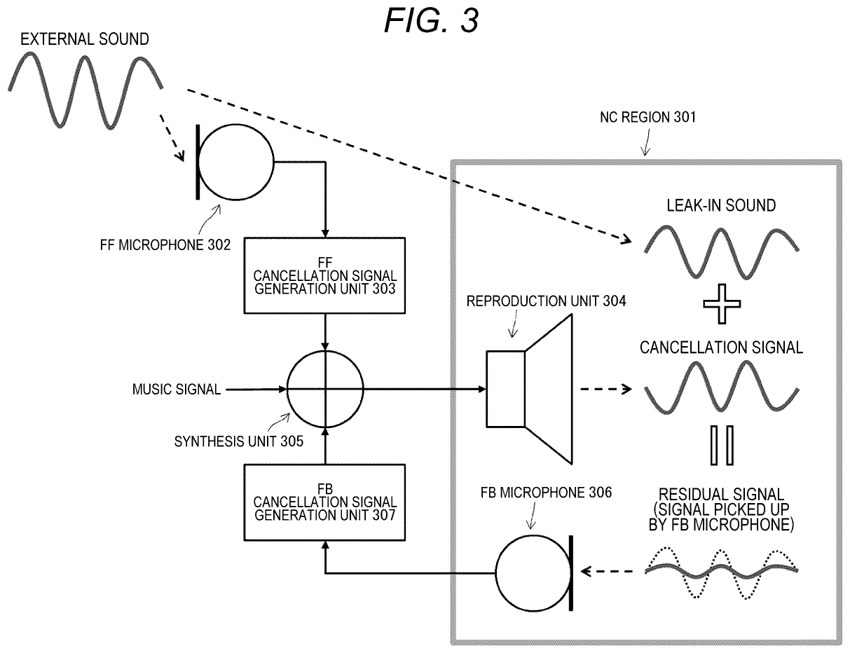

FIG. 3 schematically illustrates a functional configuration of a noise canceling system in which the feedforward method and the feedback method are combined. An NC region 301 is a target region where noise canceling is performed, and corresponds to a space between the ear of the wearer wearing the headphones and the case (housing) of the headphones. The ear canal entrance is shielded by an ear pad or the like. The illustrated noise canceling system includes a feedforward (FF) microphone 302, an FF cancellation signal generation unit 303, a reproduction unit 304, a synthesis unit 305, a feedback (FB) microphone 306, and an FB cancellation signal unit 307.

The FF microphone 302 is installed outside the NC region 301, and attempts to pick up an external sound generated outside the NC region 301. Then, the FF cancellation signal generation unit 303 analyzes a signal picked up by the FF microphone 302 and generates an FF cancellation signal having an opposite phase to cancel the analyzed external sound. The reproduction unit 304 includes an acoustic element such as a speaker installed in the NC region 301, and audio-outputs an FF cancellation signal in the NC region 301. Note that in a case where the headphones are reproducing music, the FF cancellation signal is synthesized with a music signal in the synthesis unit 305, and the reproduction unit 304 outputs an audio signal after synthesizing the music signal and the FF cancellation signal. With this arrangement, the external sound leaking into the NC region 301 and the FF cancellation signal reproduced from the reproduction unit 304 cancel each other, and it is difficult to hear the external sound in the NC region 301. In a case where the headphones are reproducing music, the external sound is canceled in the NC region 301, and it is easy to listen to the music.

Furthermore, the FB microphone 306 is installed inside the NC region 301. It is difficult to completely cancel the external sound leaking into the NC region 301 only by the FF cancellation signal, and there is a case where the external sound is left uncanceled. The FB microphone 306 picks up the residual sound left uncanceled. Then, the FB cancellation signal generation unit 307 analyzes a signal picked up by the FB microphone 306, and generates an FB cancellation signal having an opposite phase to cancel the analyzed residual sound. The FB cancellation signal is synthesized with the FF cancellation signal in the synthesis unit 305. In a case where the headphones are reproducing music, the FB cancellation signal is synthesized with the music signal together with the FF cancellation signal in the synthesis unit 305. The reproduction unit 304 outputs an audio signal obtained by synthesizing the FB cancellation signal and the FF cancellation signal. With this arrangement, the external sound left uncanceled by the FF cancellation signal and the FB cancellation signal cancel each other, and it is further difficult to hear the external sound in the NC region 301. Therefore, in a case where the headphones are reproducing music, the external sound is canceled by the FF cancellation signal and the external sound left uncanceled is canceled by the FB cancellation signal, so that it is easier to listen to music in the NC region 101. That is, accuracy of noise canceling can be further enhanced by combining the FB method with the FF method.

Hereinafter, simply referring to “noise canceling” in the present specification basically refers to active noise canceling of the feedforward method. Therefore, the noise canceling microphone in the embodiment described later is arranged not in the NC region partitioned by the ear pad but outside the NC region such as the housing.

### C. Optimal Arrangement of Noise Canceling Microphones

As described in the above section A, the hanger that adjusts the tilt angle of the housing is often incorporated in the housing so that the headphones can be correctly worn according to the shape of the temporal region different for each wearer.

Meanwhile, in order to achieve the noise canceling function and other various types of signal processing on the basis of sound information outside the headphones, headphones equipped with a plurality of microphones for noise canceling are used. In order to obtain good sound “quality” and “directivity” by performing signal processing on sound signals picked up by a plurality of microphones, it is important to arrange microphones close to the mouth of the wearer, secure a large distance between microphones, and take measures against wind noise, for example.

In the case of a structure in which the hanger 103 is attached to the outermost peripheral portion outside the case of the housing 101 as in the headphones 5900 illustrated in FIG. 59, in order to be able to pick up sound without being affected by a change in the tilt angle of the hanger 103, the arrangement of microphones is limited to the inside of the case of the housing on the inner peripheral side of the hanger 103, and it is difficult to secure a large inter-microphone arrangement. For example, when the hanger 103 exists near the front of the opening of the microphone, a change in the tilt angle of the hanger 103 in the wearing state different for each wearer affects sound information that can be picked up by the microphone, and there is also a problem that turbulence generated by air flowing around the hanger 103 and the case of the housing 101 during walking of the wearer becomes wind noise and is picked up by the microphone.

In addition, when the arrangement of the microphones is limited to the inner peripheral side of the hanger 103, there are many cases where the microphones have to be arranged in a space contributing to the acoustic circuit due to the movement of the hanger 103 (change in tilt angle or the like). In this case, not only the sound generated from the headphones 101 themselves (or speaker 106) becomes noise, but also a complicated sealed structure around the microphone is required, which makes it difficult to design and manufacture the housing.

In short, when the hanger 103 operates outside the case of the housing 101, the influence on the space in front of the microphone hole increases. For example, when the tilt angle of the hanger 103 becomes small and the hanger 103 approaches the front of the microphone hole, the air flows around the hanger 103 and the case of the housing 101 to easily generate turbulence, which causes wind noise to the microphone.

Therefore, in the present disclosure, first, the microphone is arranged on the outer peripheral side of the movable range of the hanger 103 in the case of the housing 101. Additionally, in the present disclosure, the hanger 103 is arranged in the case of the housing 101. Since at least the bifurcated portion and the rotation shaft portion supporting the housing 101 of the Y-shaped hanger 103 are arranged in the case of the housing 101, in FIG. 1, the bifurcated portion and the rotation shaft portion supporting the housing 101 of the hanger 103 are hidden in the housing 101 and are not visible. Then, only the joint portion with the slider 104 on the base side of the hanger 103 appears outside the case of the housing 101. As described later, the microphone is arranged on the outer peripheral side of the movable range of the hanger, and the hanger 103 is incorporated in the case of the housing 101, so that even if the tilt angle of the hanger 101 changes, the hanger 103 does not approach the vicinity of the microphone hole installed in the case of the housing 101, and a difference does not occur in the acquired sound of the microphone. In addition, the problem of the wind noise generated by the air around the case of the housing 101 flowing around the hanger 103 is solved.

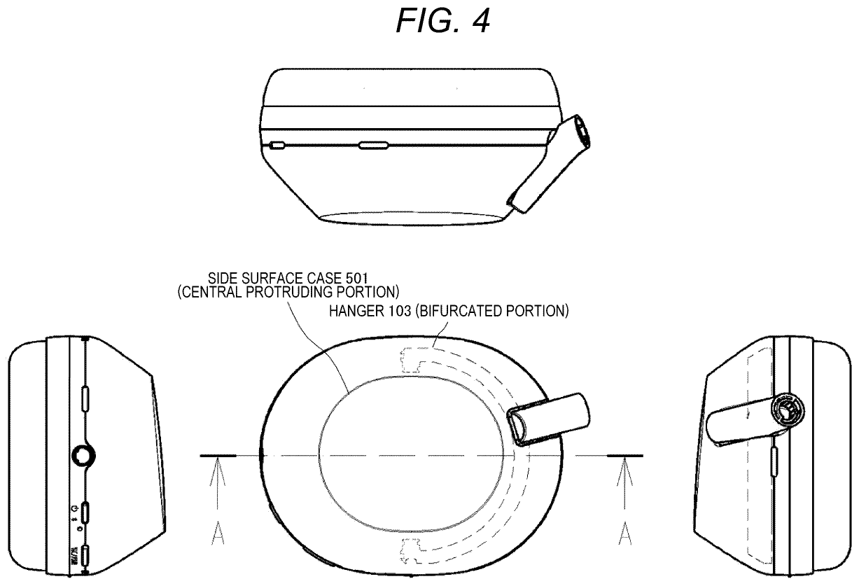

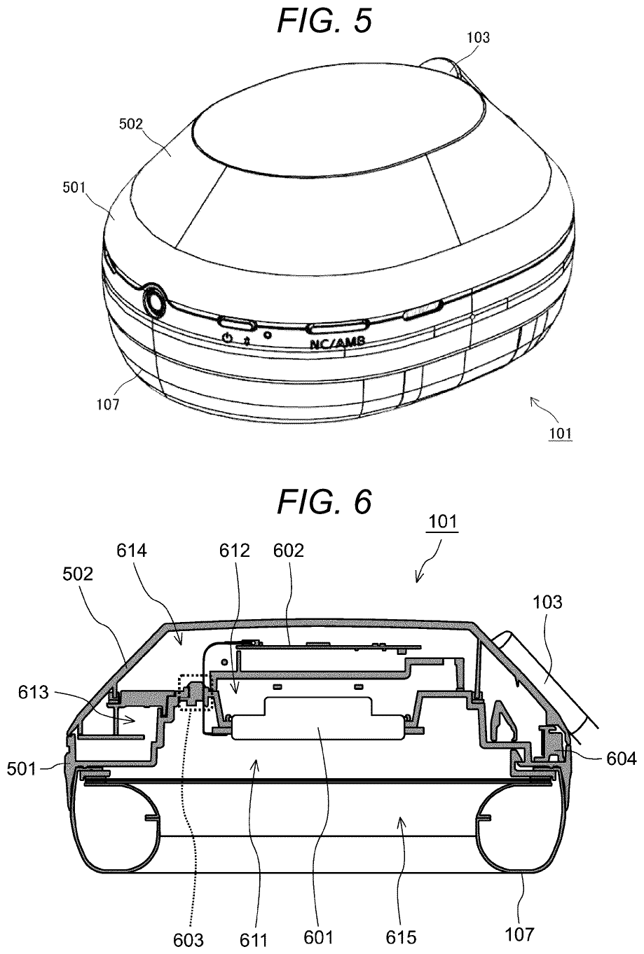

FIG. 4 illustrates a four-view diagram of the housing 101 of the headphones 100 (see FIG. 1) according to an embodiment of the present disclosure viewed from four directions. In addition, FIG. 5 is a perspective view of the housing 101, and FIG. 6 is a cross-sectional view of the housing 101 taken along line A-A of FIG. 4. As can be seen from FIGS. 4 and 5, the housing 101 is a dome-shaped three-dimensional structure, and has a substantially elliptical (or quadrangular with rounded four corners) contour. Note that while the housing 101 for the left ear is illustrated in FIGS. 4 to 6, the housing 101 for the right ear has a substantially bilaterally symmetrical shape and structure.

Referring to the perspective view of FIG. 5, the case of the housing 101 is divided into a side surface case 501 and a top surface case 502, and an ear pad 107 is attached to a bottom surface portion of the side surface case 501. Furthermore, referring to the cross-sectional view of FIG. 6, the side surface case 501 supports a diaphragm 601 as a sounding body substantially at the center such that the sound output side faces forward (downward in FIG. 6). Then, with the diaphragm 601 as a boundary, a front surface acoustic space 611 is formed on a front surface side (i.e., wearer's ear side) of the diaphragm 601, and a first back surface space 612 is formed on a back surface side (i.e., outer side) of the diaphragm 601. Furthermore, an outer peripheral space 613 is formed outside the front surface acoustic space 611 partitioned by an inner wall surface of the side surface case 501. The hanger 103 is pivotably supported on a central projection of the side surface case 501. The outer peripheral space 613 is a movable range of the hanger 103 and is an arrangement place of a plurality of microphones (only one microphone 604 is visible in cross-sectional view illustrated in FIG. 6). Additionally, in the top surface case 502, a second back surface space 614 is formed further on the back surface side than the first back surface space 612. A printed wiring board 602 on which electronic components including a drive circuit of the diaphragm 601 are mounted is arranged in the second back surface space 614. Furthermore, the inside of the ring-shaped ear pad 107 is an NC region 615 to be subjected to noise canceling. In short, the housing 101 includes the side surface case 501, the top surface case 502, the ear pad 107, and the diaphragm 601, and has the acoustic space separation component on the side farther from the ear pad 107 with respect to the diaphragm 601.

Note that the inside of the case of the housing 101 includes a first floor portion that is a non-acoustic space that does not need to be sealed and a second floor portion that is the second back surface space 614. The second floor portion requires structural sealing of the space itself in order to control the characteristics of the diaphragm 601, and is an acoustic space in which an acoustic duct (not illustrated) for adjusting the airflow volume exists in some cases. It can also be said that the housing 101 includes a plurality of acoustic spaces.

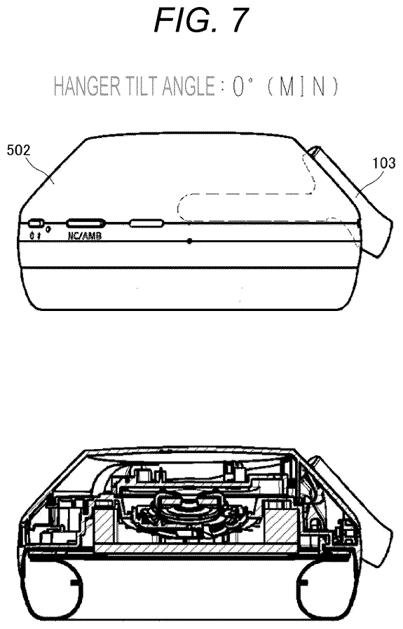

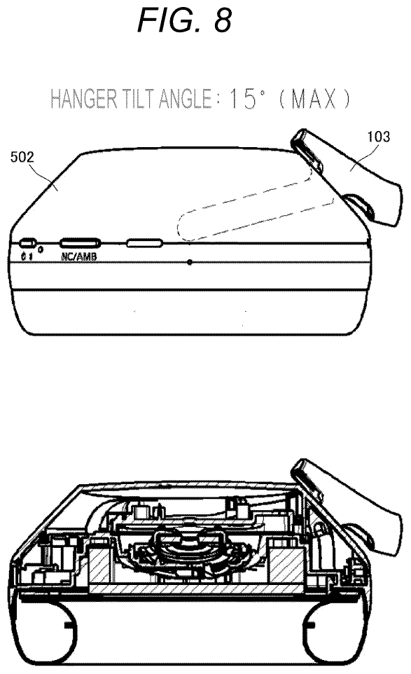

Referring again to FIG. 4, a Y-shaped bifurcated part of the hanger 103 accommodated in the case of the housing 101 is drawn by a broken line. A rotation shaft portion protruding inward at each distal end portion of the bifurcated portion of the hanger 103 is a movable shaft rotatably supported by a protruding portion at substantially the center of the side surface case 501. Then, the hanger 103 is movable in the outer peripheral space 613 in the top surface case 502 about the movable shaft. The rotation angle about the movable shaft of the hanger 103 is the tilt angle of the housing 101. The top surface case 502 is provided with a slit for moving a base portion (joint portion with headband 102) of the hanger 103. When the hanger 103 rotates about the movable shaft, the base portion of the hanger 103 can move up and down along the slit of the top surface case 502. The hanger 103 is movable at a tilt angle in a range of 0 degrees to 15 degrees. FIG. 7 illustrates a side view and a cross-sectional view of the housing 101 when the tilt angle of the hanger 103 is minimum (0 degrees). Meanwhile, FIG. 8 illustrates a side view and a cross-sectional view of the housing 101 when the tilt angle of the hanger 103 is maximum (15 degrees). It can be understood from FIGS. 7 and 8 that the top surface case 502 of the housing 101 covers the movable range of the hanger 103.

Next, the arrangement of the microphones with respect to the housing 101 having a structure in which the hanger 103 is taken into the case as illustrated in FIGS. 4 to 8 will be described.

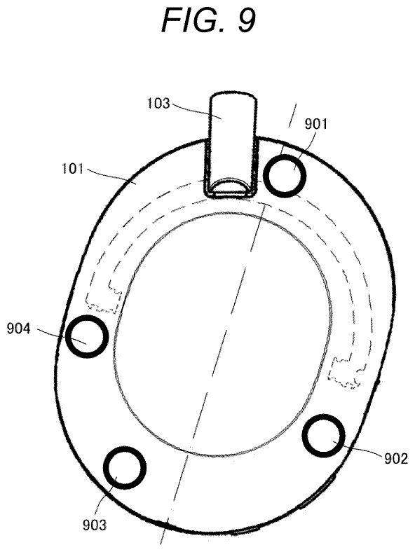

As described above, in order to obtain good sound “quality” and “directivity” by performing signal processing on sound signals picked up by a plurality of microphones, it is important to arrange microphones close to the mouth of the wearer, secure a large distance between microphones, take measures against wind noise, for example. FIG. 9 illustrates an arrangement example of microphones satisfying these three conditions. FIG. 9 illustrates a state in which four microphones 901 to 904 are arranged in the side surface case 501 which is the first floor portion of the case of the housing 101. Specifically, each microphone 901 to 904 is arranged in the outer peripheral space 613 on a side far from the ear pad 107 with the diaphragm 601 as a boundary, the outer peripheral space 613 being partitioned by the side surface case 501 and the top surface case 502. In addition, it is assumed that a slit-shaped microphone hole (not illustrated) for sound pick-up by the microphone is drilled in a wall surface (or joint portion between side surface case 501 and top surface case 501) of the side surface case 501 near a place where each microphone 901 to 904 is arranged. One microphone 901 is arranged on the outer peripheral side of the hanger 103, and the other three microphones 902 to 904 are arranged in consideration of other structures and acoustic characteristics. In the present disclosure, since the hanger 103 is incorporated in the case of the housing 101, even if the tilt angle of the hanger 103 changes, the hanger 103 does not approach the vicinity of the microphone hole for the microphone 901, and the problem of wind noise is solved. Note that the plurality of microphones 901 to 904 may be arranged in either the side surface case 501 as the first floor portion or the top surface case 502 as the second floor portion, but it can be said that it is more preferable to arrange the plurality of microphones in the side surface case 501 as the first floor portion from the viewpoint of securing a large inter-microphone distance.

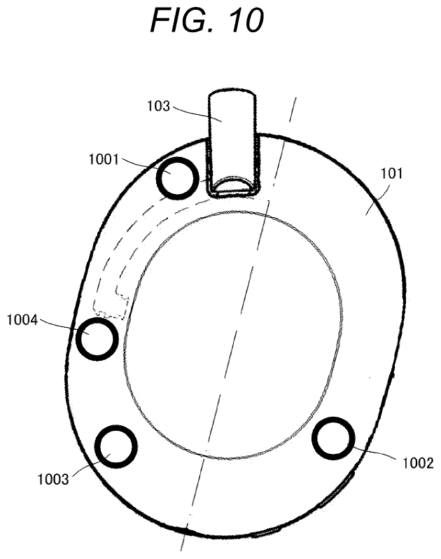

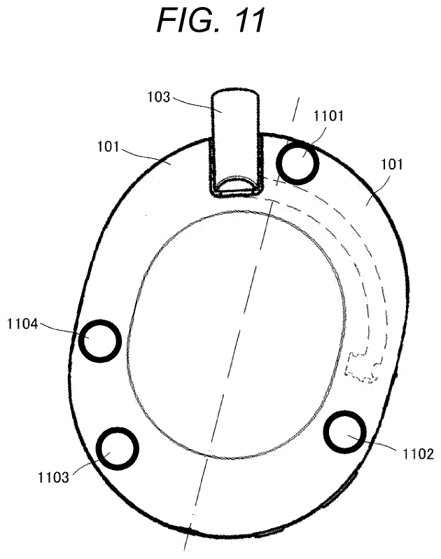

FIG. 9 illustrates the arrangement example of the four microphones 901 to 904 in a case where the hanger 103 has a Y-shape and has two movable shafts. FIGS. 10 and 11 illustrate an arrangement example of four microphones 1001 to 1004 and 1101 to 1104 in a case where the hanger 103 has one movable shaft. In either case, one microphone 1001 or 1101 is arranged on the outer peripheral side of the hanger 103, and the other three microphones 1002 to 1004 or 1101 to 1104 are arranged in consideration of other structures and acoustic characteristics.

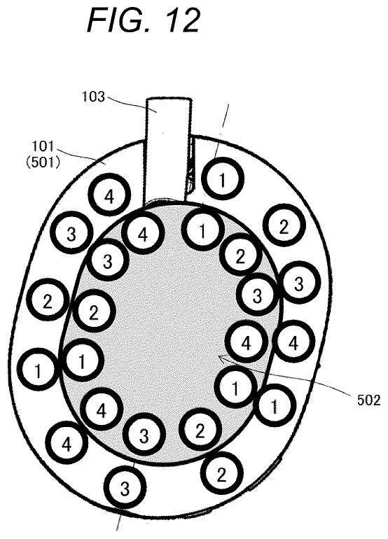

FIG. 12 collectively illustrates microphone arrangement examples of a plurality of patterns. Note, however, that in FIG. 12, the arrangement places of the microphones of the same set are represented by encircled numerals of the same value. That is, FIG. 12 illustrates microphone arrangement examples of four patterns numbered 1 to 4. As described above, the case of the housing 101 includes the side surface case 501 and the top surface case 502. The first floor portion including the side surface case 501 is a non-acoustic space that does not need to be sealed, while the second floor portion including the top surface case 502 is an acoustic space that requires structural sealing of the space itself in order to control the characteristics of the diaphragm. In any of the patterns illustrated in FIG. 12, one microphone is arranged on the outer peripheral side of the hanger 103, and the other microphones are arranged in any of the side surface case 501 and the top surface case 502 in consideration of other structures and acoustic characteristics. In FIG. 12, the portion of the top surface case 502 in the upper surface of the housing 101 is drawn in gray. The other part of the upper surface is the side surface case 501.

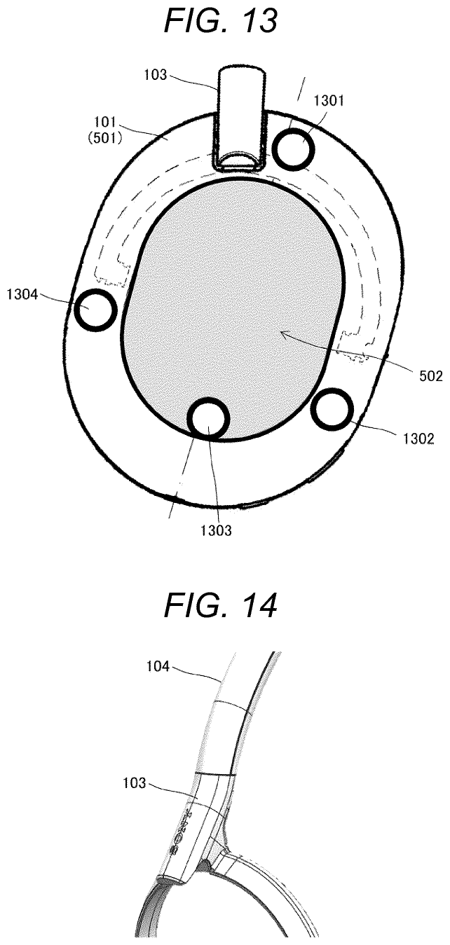

Furthermore, FIG. 13 illustrates an arrangement example in which four microphones 1301 to 1304 are arranged separately in a first floor portion and a second floor portion of the housing 101. In this example, too, one microphone 1301 is arranged on the outer peripheral side of the hanger 103, and the other microphones 1302 to 1304 are arranged in consideration of other structures and acoustic characteristics. In FIG. 13, too, the portion of the top surface case 502 in the upper face of the housing 101 is drawn in gray. The other part of the upper surface is the side surface case 501.

Regarding the microphone arrangement method described in this section C, main features and effects thereof will be summarized.

(1) In the headphones 100 having the structure in which the housing 101 is supported via the hanger 103, if a microphone can be arranged at a place on the outer peripheral side of the hanger 103 of the housing 101, it is easy to secure a larger distance between the microphone and a microphone arranged at a position close to the mouth of the wearer of the headphones 100.

(2) The movable part of the hanger 103 is arranged in the case of the housing 101. Even if the tilt angle of the hanger 103 changes due to the shape of the side surface of the head of the wearer of the headphones 100 or the like, the space in front of the microphone hole is not affected, so that there is no difference in the acquired sound of the microphone. In addition, the problem of the wind noise generated by the air around the case of the housing 101 flowing around the hanger 103 is solved.

(3) The housing 101 has a structure in which one or more spaces (first back surface space 612 and second back surface space 614) different from the space (outer peripheral space 613) in which the hanger 103 and the microphone are present exist on a side far from the ear pad 107 (or human body) with the diaphragm 601 as a boundary. Therefore, by arranging the microphone in the outer peripheral space 613 that is a non-acoustic space, the microphone can pick up external sound while suppressing the influence of the sound generated from the diaphragm 601. In addition, since structural sealing of the microphone is unnecessary, howling resistance is improved, in other words, noise canceling performance is improved.

### D. Slider Structure

As described in the above section A, the slider 104 is coupled to the hanger 103 at the lower end, and has a slide function of adjusting the length by sliding in the extending direction of the headband 102 and a twist function of rotating the hanger 103 about the center line of the headband 102 to adjust the housing 101 to follow the shape of the temporal region of the wearer (or inclination of ear). However, in the structure of conventional headphones, there has been a problem in both cases of using the slide function and using the twist function of the slider.

First, the problem of the slide function of the slider 104 will be described. In order to improve marketability and quality, it is important to prevent a cable (hereinafter also referred to as “connection cable”) that electrically connects the left and right housings 101 from being seen when the slider is largely pulled out from the headband 102 for the sake of appearance, and to make the headband 102 and the slider 104 have a lighter structure. However, conventionally, the connection cable has been sandwiched between two or more components to prevent it from being seen for the sake of appearance, or exposure of the connection cable has been allowed for the sake of weight reduction.

Next, the problem of the twist function of the slider 104 will be described. In a case where the headband 102 and the slider 104 have a flat cross-sectional shape as in the headphones 5900 illustrated in FIG. 59, when the hanger 103 is twisted and rotated according to the shape of the temporal region of the wearer, a step is formed between the slider 104 and the hanger 103 as illustrated in FIG. 60. The rotation angle of the hanger 103 varies and the step shape varies depending on the difference in the shape of the temporal region for each wearer. For this reason, there is a difference in the turbulence generated by the air flowing around the hanger 103 and the case of the housing (not illustrated in FIG. 60) when the wearer walks, for example. As described in the above section C, in a case where the microphone is arranged at a place on the outer peripheral side of the hanger 104 of the housing, the environment in which the microphone picks up sound changes due to the step between the slider 104 and the hanger 103, and thus, there is a concern about the influence on the microphone characteristics and the noise canceling performance.

In addition, when a step is generated between the slider 104 and the hanger 103 as illustrated in FIG. 60 due to the twist rotation of the hanger 103, there is also a problem that the aesthetic appearance is impaired.

Therefore, in the present disclosure, at least the portion of the slider 104 joined to the hanger 103 has a cylindrical shape so as not to cause a step between the slider 104 and the hanger 103 at the time of twist rotation of the hanger 103. In addition, the slider 104 has a hollow cylindrical structure, only the twist shaft portion of the hanger 103 is inserted into the hollow cylinder, and the connection cable from the housing 101 is inserted into and contained in the hollow cylinder, so that the connection cable is not exposed when the slider 104 slides in the extending direction of the head band 102.

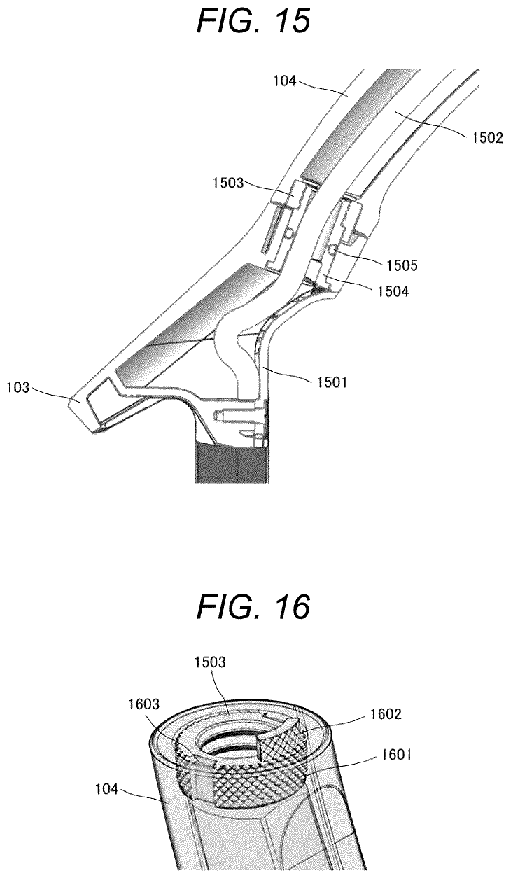

FIG. 14 illustrates a joint portion between the slider 104 and the hanger 103 in an enlarged manner in the headphones 100 according to the present disclosure. The slider 104 has a seamless short-arc hollow pipe shape and is inserted through a hollow cylindrical headband 102 (not illustrated in FIGS. 14 and 15) to be the sheath side. The slider 104 can adjust the position of the housing 101 by sliding in an extending direction substantially coinciding with the center line of the slider 104 itself. Furthermore, the slider 104 couples the hanger 103 that supports the housing 101 (not illustrated in FIGS. 14 and 15) so that it is rotatable (twistable) about the center line of the slider 104 itself.

FIG. 15 illustrates a cross section of the joint portion between the slider 104 and the hanger 103 in the headphones 100 according to the present disclosure. In the hanger 103, a lid hanger 1501 on the back surface side is removable, and the lid hanger 1501 can be removed to route a connection cable 1502 into the hanger 103. One end of the connection cable 1502 is connected to the printed wiring board (described above) in the housing 101, and the other end is inserted into the slider 104 that is the hollow cylinder via the hanger 103. Therefore, since the connection cable 1502 is contained in the short-arc hollow pipe-shaped slider 104, the connection cable 1502 is not exposed regardless of the position where the slider 104 slides in the extending direction of the headband 102. As can be seen from FIGS. 14 and 15, the hanger 103 and the slider 104 have a cylindrical structure having the same diameter, and are coaxially coupled to each other in a rotatable (twistable) manner.

The internal configuration of the joint portion between the slider 104 and the hanger 103 and the twist function, that is, the operation of rotating the hanger 103 about the center line of the slider 104 will be described with reference to FIG. 15.

The slider 104 is made of resin molded in a short-arc hollow pipe shape as described above. A shaft twist slider 1503 is inserted into a joint portion of the slider 104 and the hanger 103 near the lower end of the slider 104 to integrate the slider 104 and the hanger 103. The shaft twist slider 1503 is a metal nut component for fastening to a shaft twist 1504 on the hanger 103 side, and has a female screw structure formed on the inner peripheral side.

On the other hand, a male screw is formed at the distal end of the shaft twist 1504 on the hanger 103 side. When the lid hanger 1501 is removed, the inside of the hanger 103 becomes accessible. In a state where the lid hanger 1501 is removed, the shaft twist 1504 is inserted from below and aligned so as to be coaxial with the lower end surface of the shaft twist slider 1503 inserted in the slider 104, and then the male screw at the distal end of the shaft twist 1504 is screwed to the female screw at the lower end of the shaft twist slider 1503 to form the fastening structure of the shaft twist 1504 and the shaft twist slider 1503. Additionally, an O-ring 1505 is attached near the middle of the shaft twist 1504. When the shaft twist 1504 and the shaft twist slider 1503 are fastened by the screw, the hanger 103 is in a coupled state in which it does not come off from the slider 104. In this fastened state, the hanger 103 is rotatable about the center line of the slider 104 only by the frictional force generated by the O-ring 1505, so that the twist function is achieved.

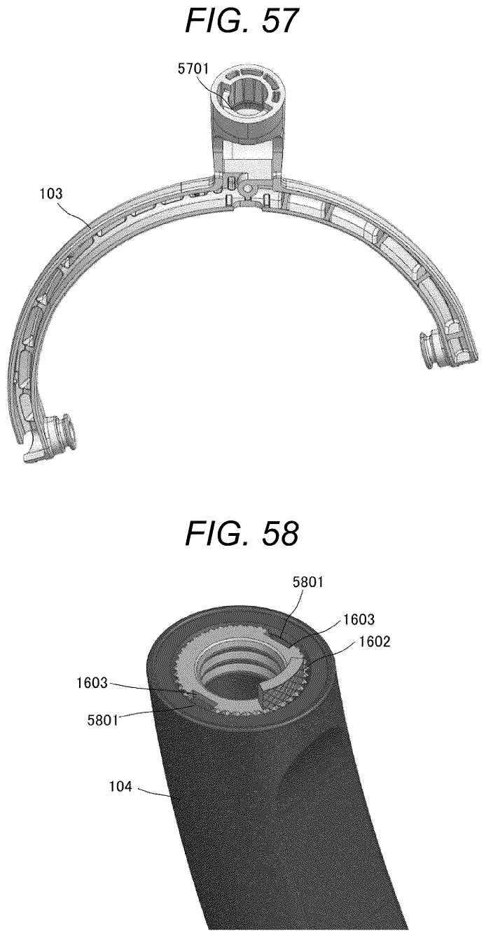

FIG. 16 illustrates an enlarged, upside-down view of the vicinity of the lower end of the slider 104 into which the shaft twist slider 1503 is inserted. Referring to FIG. 16, a knurled portion 1601 having fine and regular uneven shapes is formed on the outer periphery of the shaft twist slider 1503 including a metal nut component. Additionally, a protrusion 1602 for restricting rotation with respect to the hanger 103 is formed on the upper end edge of the knurled portion 1601. On the other hand, FIG. 57 illustrates the vicinity of the upper end of the hanger 103 in an enlarged manner. At the joint portion with the slider 104 on the hanger 103 side, a recess 5701 is formed in a range of the rotation angle in which the protrusion 1602 of the shaft twist slider 1503 is allowed to pass. In a state where the slider 104 and the hanger 103 are joined, the protrusion 1602 of the shaft twist slider 1503 is accommodated in the recess 5701 at the distal end of the hanger 103, and the hanger 103 can rotate, that is, can twist about the center line of the slider 104 within the range of the angle in which the recess 5701 is formed.

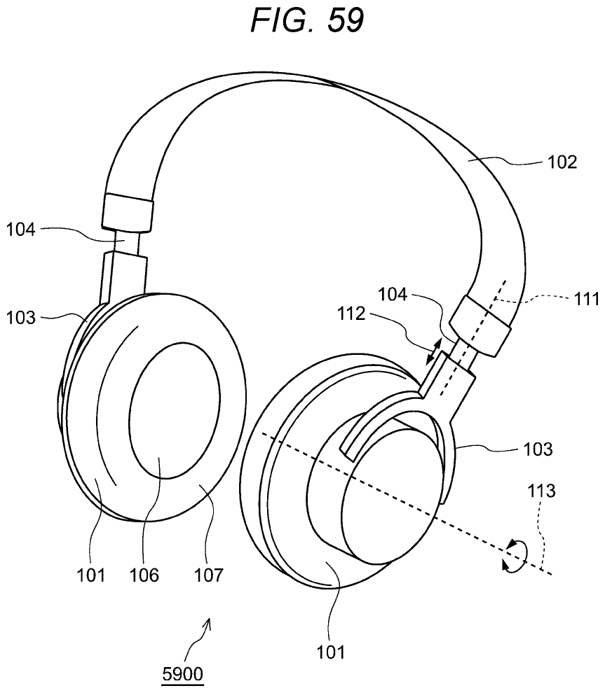

Additionally, referring to FIG. 16, a slit 1603 is formed at two locations of the knurled portion 1601 on the outer periphery of the shaft twist slider 1503. In FIG. 16, the slider 104 is drawn translucently, which is hard to see. Therefore, in FIG. 58, the slider 104 is filled in with a dark color. The slider 104 is provided with projections 5801 at two locations at the end portion of the hollow cylindrical inner wall. Therefore, the slit 1603 of the knurled portion on the shaft twist slider 1503 side and the projection 5801 on the inner periphery of the slider 104 are fixed by fitting, and rotate integrally even if torque is generated around the center line.

As described above, the slider 104 includes a resin having a short-arc hollow pipe shape, and the shaft twist slider 1503 including of a metal nut component is inserted at the end portion. A method of creating the slider 104 will be described with reference to the drawings as appropriate.

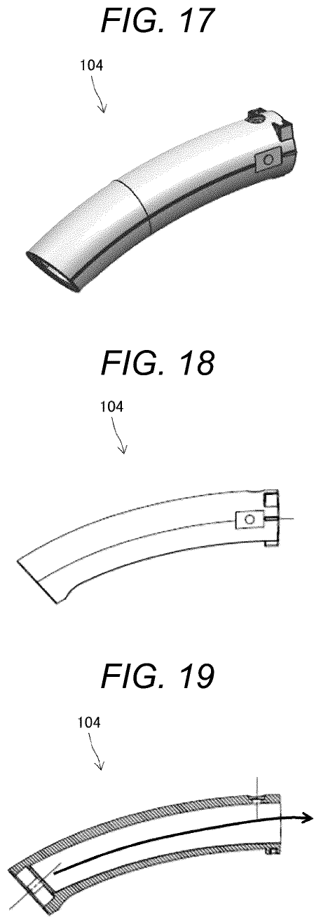

FIG. 17 is a perspective view of the slider 104 alone. Additionally, FIG. 18 is a side view of the slider 104. Furthermore, FIG. 19 illustrates a cross-sectional view of the slider 104 cut along the center line. It is possible to create the slider 104 including an arc-shaped hollow molded article as illustrated in FIGS. 17 to 19 by one component by moving the mold along the arc in the direction of the arrow in FIG. 19. By forming the slider 104 with one component using the arc slide structure, it is possible to obtain high rigidity sufficient to support the housing 101 with light weight and thin outer diameter. Mold slides are known in the art as one technology for injection molding undercuts (“shapes that do not come off with normal mold movement”) with a mold.

Furthermore, the shaft twist slider 1503, which is a metal nut component, is inserted into the end portion of the molded slider 104 by thermal press fitting, so that the structure as illustrated in FIG. 16 can be completed. As a method of generating heat in thermal press-fitting, there is a method called impulse (heating by current). Note that examples of an alternative fastening means to thermal press-fitting include adhesion, a molding insert, and ultrasonic press-fitting.

FIG. 20 is an enlarged view of a joint portion between the slider 104 and the hanger 103, including the housing 101. The hanger 103 and the slider 104 have a cylindrical structure having the same diameter. In FIG. 20, as indicated by an arrow 2002, the hanger 103 and the slider 104 are coaxially coupled to each other in a rotatable manner, that is, in a twistable manner. Additionally, as described in the above section C, one microphone is arranged on the outer peripheral side of the hanger 103 (see FIG. 13, for example), and therefore, a slit-shaped microphone hole 2001 is drilled near the base of the hanger 103.

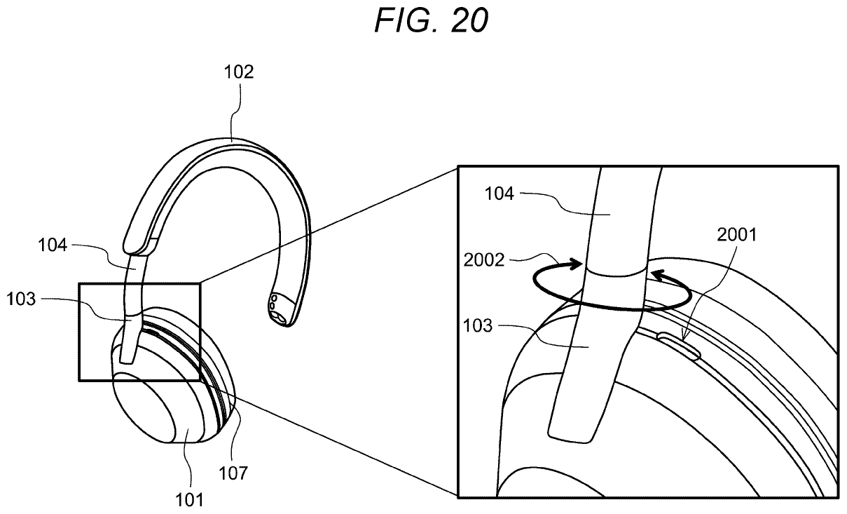

FIG. 21 illustrates a state in which air flows around the vicinity of the joint portion between the slider 104 and the hanger 103 when the wearer walks, for example. In FIG. 21, air flows are indicated by arrows 2101 and 2102. Note, however, that the arrow 2101 indicates a flow of air passing through the front side of the hanger 103 in FIG. 21, and the arrow 2102 indicates a flow of air passing through the back side of the hanger 103 in FIG. 21. Since the hanger 103 and the slider 104 have a cylindrical structure having the same diameter and the same axis, even if the hanger 103 rotates about the center line of the headband 102 by the twist function, no step (see FIG. 60) is generated between the slider 104 and the hanger 103, and an event such as changing of the step shape depending on the twist angle of the hanger 103 does not occur. Therefore, even if the hanger 103 is twisted, the environment in which the microphone picks up sound through the microphone hole 2001 arranged near the base of the hanger 103 hardly changes, and thus, there is no influence on the microphone characteristics and the noise canceling performance.

Regarding the structure of the slider described in this section D, main features and effects thereof will be summarized.

(1) Since the hanger 103 and the slider 104 having a cylindrical structure of the same diameter are coaxially coupled to each other in a rotatable manner to form a twist function, no step is generated even if the twist angle of the hanger 103 changes.

(2) By using the arc slide structure for the slider 103 and forming the slider 103 with one component including the shaft twist slider 1503, it is possible to obtain high rigidity sufficient to support the housing 101 while achieving the slide function and the twist function with light weight and thin outer diameter.

(3) By adopting a structure in which no step is generated at a joint portion between the hanger 103 and the slider 104 when the hanger 103 is twisted, it is possible to arrange a microphone near the base of the hanger 103. Even if the twist angle of the hanger 103 changes due to the difference in the shape of the temporal region for each wearer of the headphones 101, the microphone characteristics are not affected.

### E. Ear Pad Structure

### E-1. Moisture Permeable Synthetic Leather Ear Pad Structure

The ear pad 107 for headphones is required not to be stuffy for long-time comfort. As a method of coping with stuffiness, a method of imparting moisture permeability or air permeability to the material is known. On the other hand, as described in the above section B, the ear pad has a role of passive noise canceling that maintains the sound insulation property of the NC region. For example, it is not possible to apply, to headphones having a low-range reproduction of 100 Hz or less or a noise canceling function, an ear pad whose sealability decreases due to its air permeability.

Synthetic leather and the like with moisture absorbing and releasing particles on the surface of synthetic leather are also known, but the effect of moisture absorption is limited, and there is also a problem of performance deterioration over time, such as hydrolysis. In addition, a film having moisture permeability is generally present, but it is not suitable as an exterior component of headphones due to problems of strength and appearance.

Therefore, in this section E-1, a structure of an ear pad that achieves both sound the insulation property (or soundproofing property) and moisture permeability according to the present disclosure will be described.

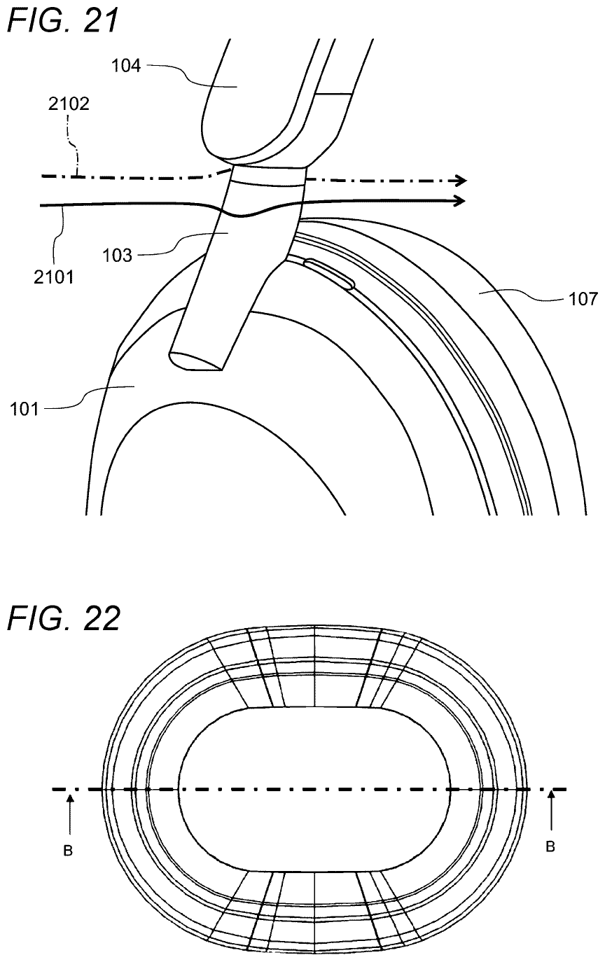

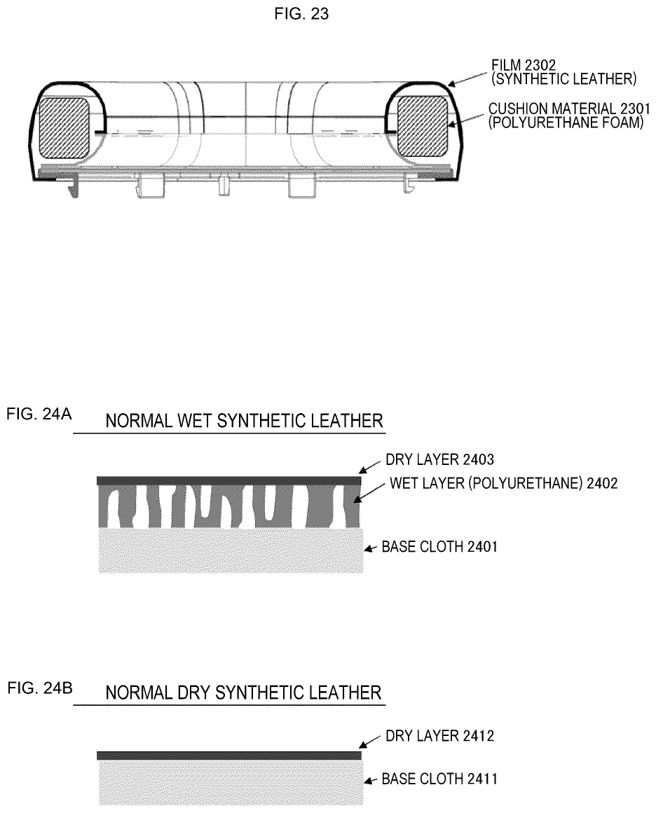

FIG. 22 illustrates a plan view of the ear pad 107 applied to the headphones 100 illustrated in FIG. 1. Additionally, FIG. 23 is a cross-sectional view of the ear pad 107 illustrated in FIG. 22 taken along line B-B. As is known, the ear pad 107 is fixed to the bottom surface of the housing 101. In the present disclosure, the ear pad 107 is replaceably attached to the housing 101. Details will be described in the following section E-2.

As can be seen from FIG. 22, the ear pad 107 has a ring-shaped structure and has a substantially elliptical (or quadrangular with rounded four corners) contour. The outer contour of the ear pad 107 is substantially the same as that of the bottom surface of the housing 101. Furthermore, as can be seen from FIG. 23, the ear pad 107 is configured by wrapping a cushion material 2301 including an elastic material such as polyurethane foam with a film 2302 such as synthetic leather.

Synthetic leather used for the film is usually (conventionally) formed on the outermost surface with a polyurethane film produced by a dry process. This polyurethane film is a non-porous film having a thickness of about 30 to 50 μm, and has no air permeability and poor moisture permeability. For reference, FIG. 24(A) illustrates a cross-sectional structure of a normal wet synthetic leather, and FIG. 24(B) illustrates a cross-sectional structure of a normal dry synthetic leather. As illustrated in FIG. 24(A), a normal wet synthetic leather is configured by bonding a porous (or air-permeable) wet layer 2402 including polyurethane to the front surface of a base cloth 2401, and further forming a dry layer 2403 on the wet layer 2402. On the other hand, in a normal dry synthetic leather, as illustrated in FIG. 24(B), a dry layer 2412 is directly formed on the outermost surface of a base cloth 2411. Both the wet synthetic leather illustrated in FIG. 24(A) and the dry synthetic leather illustrated in FIG. 24(B) are impermeable and poor in moisture permeability.

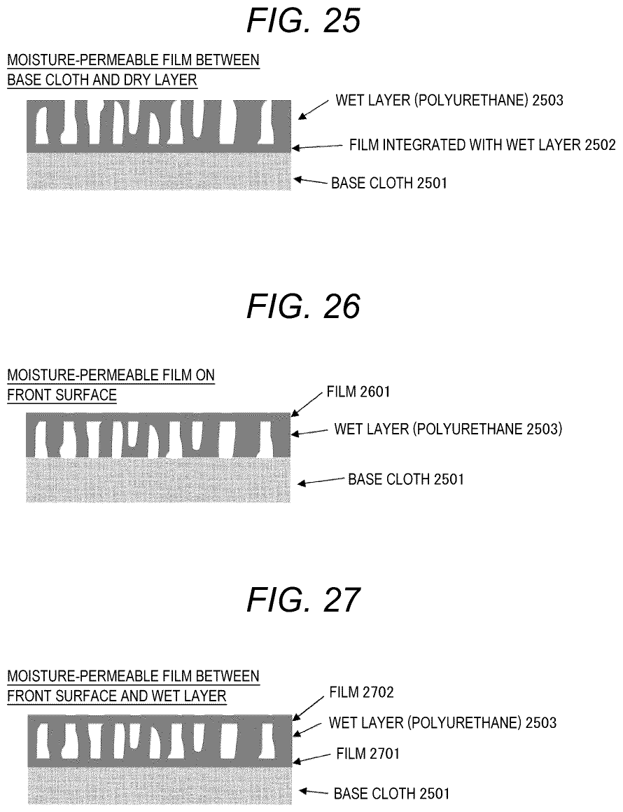

FIG. 25 illustrates a cross-sectional structure of an example of synthetic leather used for a skin containing a urethane foam according to the present disclosure. The illustrated synthetic leather is configured by bonding a wet foam layer 2503 including porous (or air-permeable) polyurethane having a three-dimensional microporous structure on a base cloth 2501 of the lowermost layer, and a thin urethane film 2502 having a thickness of about 5 μm is integrated on the bottom surface side of the wet foam layer 2503. For example, the thin urethane film 2502 can be formed on the bottom surface side of the wet foam layer 2503 using a coating technology. The urethane film 2502 is air-impermeable because it does not have open cells, but has moisture permeability and fine unevenness (surface transpiration) or moisture permeability of the skin.

FIGS. 26 and 27 each illustrates a modification of the synthetic leather configured by bonding a wet foam layer onto a base cloth according to the present disclosure illustrated in FIG. 25. The example illustrated in FIGS. 26 and 27 is the same as FIG. 25 in that the base cloth 2501 and the wet foam layer 2503 are bonded to each other, but is different from the synthetic leather illustrated in FIG. 25 in that a thin urethane film 2601 is formed on the front surface side of the wet foam layer 2503 in the example illustrated in FIG. 26, and thin urethane films 2701 and 2702 are formed on both the bottom surface and the front surface of the wet foam layer 2503 in the example illustrated in FIG. 27.

In short, the synthetic leathers illustrated in FIGS. 25 to 27 have a structure in which a thin urethane film is integrated with at least one of the bottom surface or the front surface of the wet foam layer. The urethane film is air-impermeable because it does not have open cells, but has moisture permeability and fine unevenness (surface transpiration) or moisture permeability of the skin. In addition, none of the synthetic leathers illustrated in FIGS. 25 to 27 have an air-impermeable dry layer on the front surface of the wet foam layer. It can be said that the synthetic leathers illustrated in FIGS. 25 to 27 have both the sound insulation property and moisture permeability.

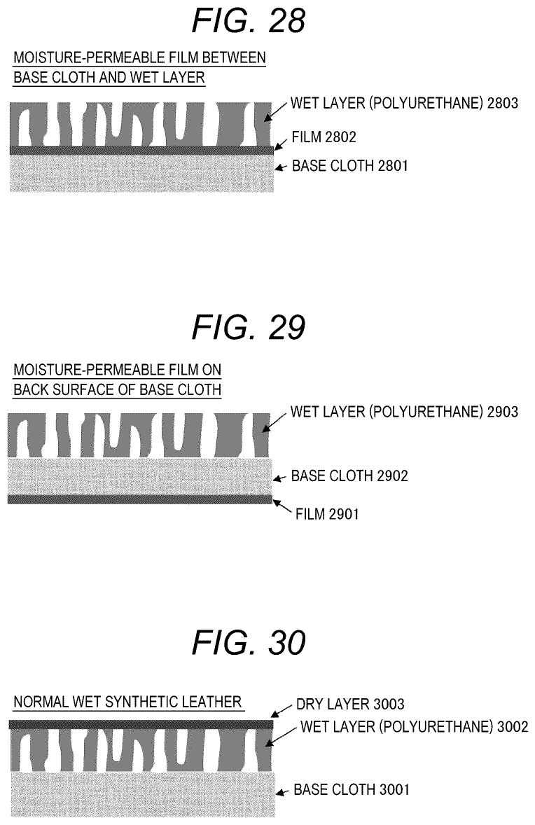

FIG. 28 illustrates a cross-sectional structure of another example of synthetic leather used for a skin containing a urethane foam according to the present disclosure. The illustrated synthetic leather is configured by bonding a wet foaming layer 2803 including porous (or air-permeable) polyurethane to the front surface of a wet base cloth 2801 having open cells (air permeability) as the lowermost layer, and an air-impermeable moisture-permeable waterproof film 2802 is arranged between the base cloth 2801 and the wet foaming layer 2803. Moreover, FIG. 29 illustrates a modification of the synthetic film illustrated in FIG. 28, which includes a base cloth and a wet foam layer and further includes an air-impermeable moisture-permeable film in combination. In the example illustrated in FIG. 29, an air-impermeable moisture-permeable waterproof film 2901 is bonded to the bottom surface side of a wet base cloth 2902, and a wet foam layer 2903 is bonded to the front surface side of the wet base cloth 2902. It can be said that the synthetic leathers illustrated in FIGS. 28 and 29 have both the sound insulation property and moisture permeability.

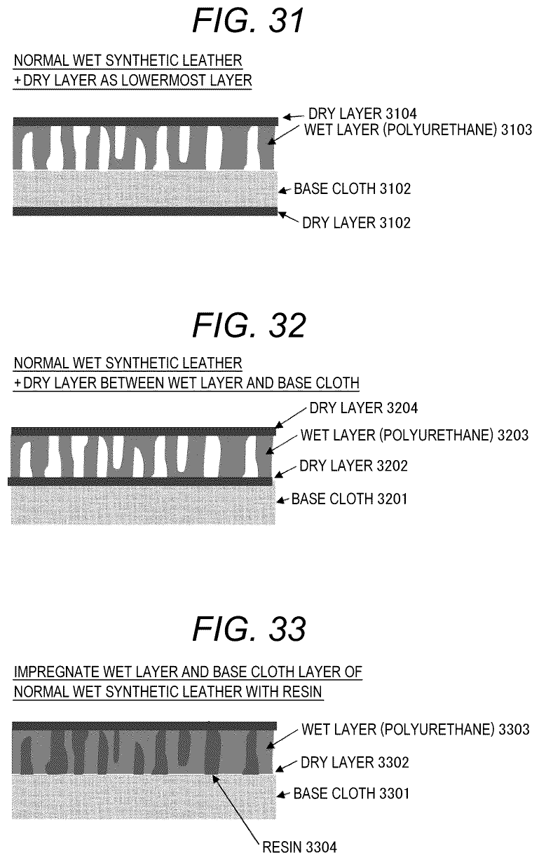

FIG. 30 illustrates a cross-sectional structure of yet another example of synthetic leather used for a skin containing a urethane foam according to the present disclosure. The illustrated synthetic leather is configured by bonding a wet foaming layer 3002 including porous (or air-permeable) polyurethane to the front surface of a base cloth 3001 as the lowermost layer, and a dry layer 3003 is further bonded to the front surface of the wet foaming layer 3002. In addition, FIG. 31 illustrates a modification of the synthetic film illustrated in FIG. 30, which includes a wet foam layer and a base cloth and further includes a dry layer in combination. In the example illustrated in FIG. 31, dry layers 3104 and 3101 are bonded to both the front surface of a wet foam layer 3103 and the bottom surface of a base cloth 3102, respectively. The synthetic leathers illustrated in FIGS. 30 and 31 can improve the sound insulation property.

FIG. 32 illustrates a cross-sectional structure of still another example of synthetic leather used for a skin containing a urethane foam according to the present disclosure. The illustrated synthetic leather is configured by bonding a wet foaming layer 3203 including porous (or air-permeable) polyurethane on a base cloth 3201 as the lowermost layer, and dry layers 3204 and 3202 are bonded to both the front surface and the bottom surface of the wet foaming layer 3203, respectively. In addition, FIG. 33 illustrates a modification of the synthetic film illustrated in FIG. 32, which includes a wet foam layer and a base cloth and has a dry layer attached to the front surface. In the example illustrated in FIG. 33, one or both of a wet foam layer 3303 and a wet base cloth 3301 having air permeability contain an impregnated material 3304. In the example illustrated in FIG. 33, a dry layer 3302 is bonded to the front surface of the wet base cloth 3301, and then bonded to the wet foam layer 3303 containing the impregnated material 3304. The impregnated material 3304 referred to herein is a resin, oil, or the like. The synthetic leathers illustrated in FIGS. 32 and 33 can improve the sound insulation property.

Regarding the moisture-permeable synthetic leather ear pad structure described in this section E-1, main features and effects thereof will be summarized.

(1) In an ear pad for headphones, in synthetic leather enclosing a cushion material including polyurethane foam or the like, by using a thin polyurethane film of about 5 to 20 μm which is air-impermeable but has moisture permeability, it is possible to achieve both the sound insulation property and moisture permeability of the ear pad.

### E-2. Replaceable Claw Ear Pad

The ear pad is attached to the acoustic surface of the housing, and has a role of providing a better wearing feeling by its cushioning property and forming the NC region by its sound insulation property. As described in the above section E-1, the ear pad has a structure in which a cushion material such as polyurethane foam is wrapped with synthetic leather. However, there is a problem that synthetic leather on the surface deteriorates over time due to the influence of perspiration and body temperature, and it is desirable that the ear pad is replaceable.

Examples of a method of fixing the ear pad to the housing include a magnet type, a bayonet type (see Patent Document 5, for example), and a claw fixing type. Among these, the claw fixing type ear pad can be reduced in weight, but it is difficult to perform an operation of flexing the claw from the case surface of the housing, and thus, for example, it is difficult for the end user to remove and replace the ear pad.

Therefore, in the present disclosure, the claw fixing type is adopted as a method of fixing the replaceable ear pad 107 to the case of the housing 101, and a structure of a fixing claw and a method of fixing the claw fixing type ear pad 107 that facilitate the removal work by the end user are proposed.

In the present embodiment, it is assumed that fixing claws are arranged at six locations on the inner peripheral side of the bottom surface of the ring-shaped ear pad 107, and the ear pad 107 is attached to the acoustic surface of the housing 101 by inserting and locking each fixing claw into the corresponding claw fixing portion on the housing 101 side. Furthermore, by releasing the engagement state of each fixing claw with the claw fixing portion, the ear pad 107 can be removed from the housing 101 and be replaced. Note that in order to ensure acoustic sealing (or passive noise canceling function in NC region) by the ear pad 107, it is desirable to fix the ear pad 107 to the acoustic surface of the housing 101 with the fixing claws and the claw fixing portions at a plurality of locations. In the present embodiment, fixing is performed at six locations, but fixing may be performed at five or less locations or seven or more locations as long as requirements such as acoustic sealing are satisfied.

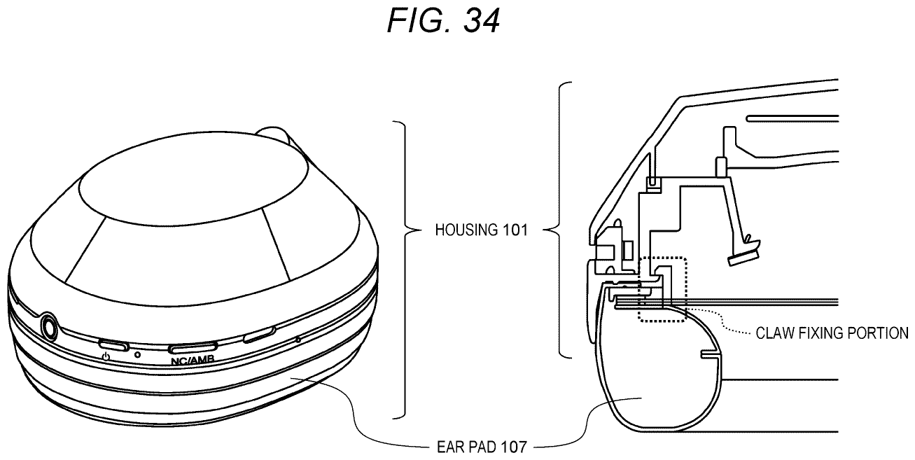

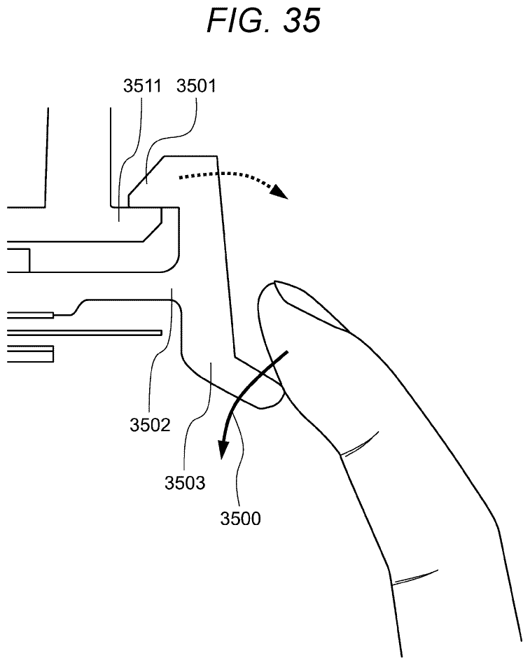

FIG. 34 illustrates a cross-sectional view of the ear pad 107 and the housing 101 cut so as to include the vicinity of the claw fixing portion on the housing 101 side in a state where the fixing claw on the ear pad 107 side is locked. In addition, FIG. 35 further illustrates the fixing claw on the ear pad 107 side and the claw fixing portion on the housing 101 side in an enlarged manner in the cross-sectional view illustrated in FIG. 34. The fixing claw on the ear pad 107 side has a claw fitting structure to be engaged with the claw fixing portion on the housing 101 side. Hereinafter, the claw fitting structure and the method of releasing the fitted state of the claw fitting structure will be described with reference to FIGS. 34 and 35.

As illustrated in FIG. 35, the fixing claw has a T-shaped cross section, and a projection 3501 protruding slightly in the direction of the foot of the T shape (or downward direction of T shape, left direction in FIG. 35) is formed at one distal end of the T-shaped head. On the other hand, on the housing 101 side, a claw fixing portion including a rib 3511 is arranged at a portion facing the projection 3501. Then, the ear pad 107 is fixed to the housing 101 by the claw fitting structure in which the projection 3501 on the fixing claw side is locked to the rib 3511 on the housing 101 side.

In addition, a leg portion of the T shape of the fixing claw is flexible and serves as a hinge 3502. When the hinge 3502 flexes, the projection 3501 at the distal end is separated from the rib 3511 on the housing 101 side, so that the fitting state is released and the fixing claw can be removed from the claw fixing portion. In the fixing claw illustrated in FIG. 35, the distal end of the T-shaped head opposite to the projection 3501 includes a hook-shaped finger hook portion 3503 that is bent back. Note, however, that the fixing claw is assumed to be attached to the ear pad 107 such that the projection 3501 faces the outer peripheral side of the ring and the finger hook portion 3503 faces the inner peripheral side. Then, as illustrated in FIG. 35, when the fingertip is hooked on the finger hook portion 3503 and pressed in the direction of an arrow 3500 in FIG. 35, the hinge 3502 flexes, and the projection 3501 on the opposite side is lifted up using the “principle of leverage” and detached from the rib 3511. Thus, the fitted state can be easily released and the fixing claw can be easily detached from the claw fixing portion. The finger hook portion 3503 is supported by the hinge 3502 so as to face upward and be exposed from the inner periphery of the ring-shaped ear pad 107.

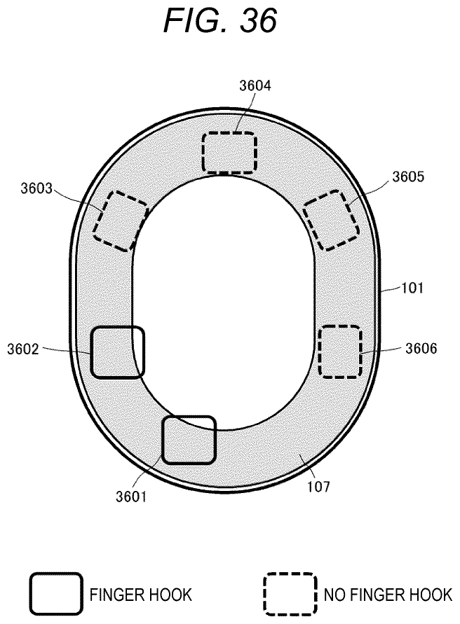

As described above, in order to ensure acoustic sealing, the ear pad 107 has a claw fitting structure with (the acoustic surface of) the housing 101 including the fixing claw and the claw fixing portion at a plurality of locations (six locations in present example). Each claw fitting structure is as illustrated in FIGS. 34 and 35. FIG. 36 illustrates an example in which six claw fitting structures are arranged in the ear pad 107 and the housing 101. In FIG. 36, six locations where claw fixing portions 3601 to 3606 are arranged are indicated by two solid squares and four broken squares. As illustrated in the drawing, the claw fitting structures at six locations are dispersedly arranged along the substantially elliptical contour of the ear pad 107 and the housing 101. By evenly arranging the plurality of claw fitting structures along the substantially elliptical contour, the ear pad 107 can be firmly attached to the acoustic surface of the housing 101, and acoustic sealing (or passive noise canceling function in NC region) by the ear pad 107 can be secured.

There are two types of fixing claws used in the claw fixing portions 3601 to 3606, that is, a type having the finger hook portion 3503 as illustrated in FIG. 35 and a type not having the finger hook portion (not illustrated). Among the six places where the claw fixing portions 3601 to 3606 are arranged illustrated in FIG. 36, a fixing claw having the finger hook portion is applied to the claw fixing portions 3601 and 3602 at the two locations indicated by solid squares, and a fixing claw not having the finger hook portion is applied to the claw fixing portions 3603 to 3606 at the four locations indicated by broken squares. The fixing claws having the finger hook portions 3503 at the two claw fixing portions 3601 and 3602 indicated by solid squares are slightly exposed to the inner peripheral side from the contour of the ear pad 107. Since the finger hook portion 3503 of the fixing claw faces the inner peripheral side (described above), such an arrangement allows the user's fingertip to easily access the finger hook portion 3503.

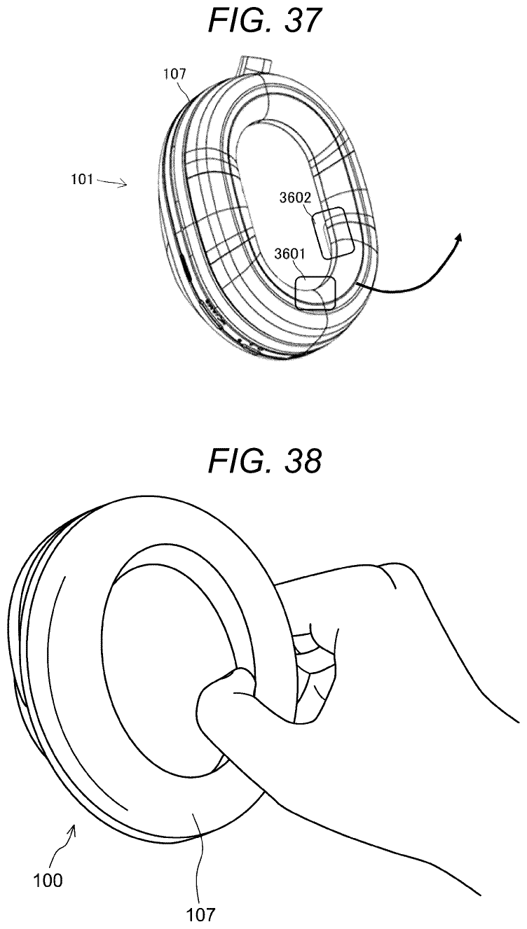

As can be seen from FIG. 36, the two locations to which the fixing claw having the finger hook portion 3503 is applied are arranged side by side in a range where a curvature radius R of the elliptical ear pad 107 is small. FIG. 37 illustrates, in perspective view, arrangement places of the two claw fixing portions 3601 and 3602 arranged side by side in the range where R is small. In addition, FIG. 38 illustrates a state in which a finger is inserted into one of the two claw fixing portions 3601 and 3602 to remove the fixing claw. By arranging the claw having the finger hook portion in the range where R of the ear pad 107 is small, as illustrated in FIG. 38, it is possible to warp the entire ear pad 107 only by inserting the finger into the range where R is small and applying a force to the ear pad 107 with the finger in the direction indicated by the arrow in FIG. 37. Thus, the operability of removing the fixing claw is improved in the remaining four claw fixing portions 3603 to 3606 not having the finger hook portion.

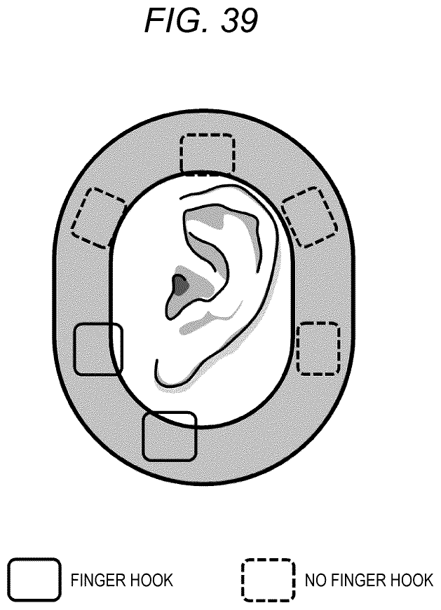

Comparing the fixing claw of the type having the finger hook portion 3503 with the fixing claw of the type having no finger hook portion, the size of the fixing claw of the type having the finger hook portion is increased by the hook-shaped finger hook portion. Therefore, as illustrated in FIG. 39, the fixing claw is exposed inward of the contour of the ring-shaped ear pad 107. On the other hand, when the headphones 100 are worn, the ear of the wearer is inserted into the ear pad 107. FIG. 39 also illustrates a state in which the ear (auricle) is inserted into the elliptical interior of the ear pad 107. As illustrated in FIG. 39, it should be understood that the fixing claw having the finger hook portion is arranged at the front of the face so as not to come into contact with the ear and prevent adverse influence on the wearing feeling. In the fixing claw of the type having the finger hook portion, since the finger hook portion 3501 is exposed from the inside of the contour of the elliptical ear pad 107, it can also be said that the finger hook portion 3501 is arranged at a visible position.

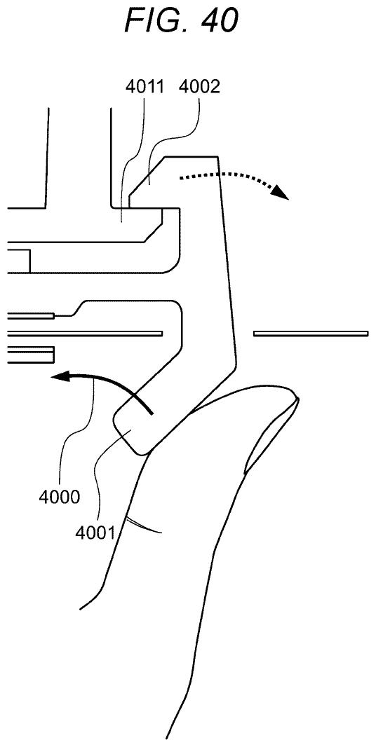

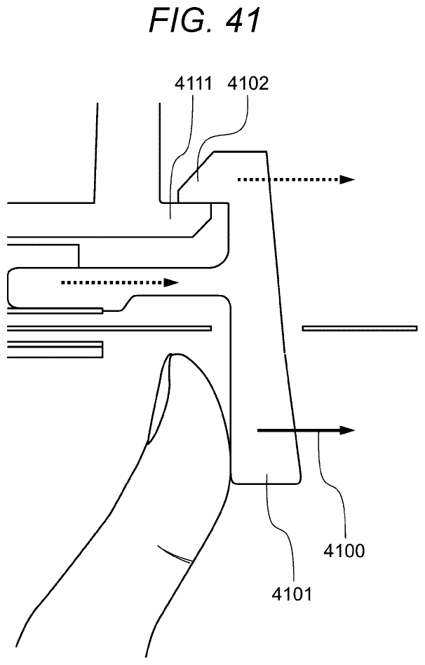

FIGS. 40 and 41 illustrate modifications of the finger hook portion of the fixing claw. The direction of pressing with the fingertip to release the state of fitting with the housing 101 and remove the fixing claw varies depending on the shape of the finger hook portion. In FIGS. 40 and 41, directions in which the fixing claw is pressed by the fingertip to be removed are indicated by arrows. In the modification illustrated in FIG. 40, a finger hook portion 4001 is pressed by the fingertip in the direction of an arrow 4000 in FIG. 40 (direction toward back of claw), and a projection 4002 at the distal end on the opposite side is lifted and detached from a rib 4011 on a housing 101 side using the “principle of leverage” similarly to the example illustrated in FIG. 35. Alternatively, in the modification illustrated in FIG. 41, a finger hook portion 4101 is pressed by the fingertip in a direction of an arrow 4100 in FIG. 41 (direction toward front of claw) to flex the entire claw, and a projection 4102 at the distal end on the opposite side is lifted and detached from a rib 4111 on a housing 101 side.

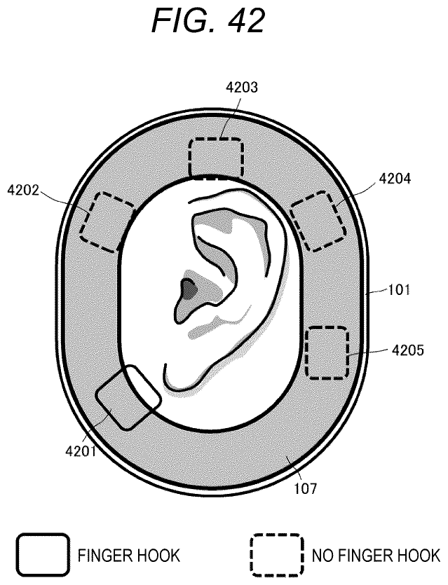

FIG. 42 illustrates another example in which a plurality of claw fixing portions for fixing the ear pad 107 to the acoustic surface on the housing 101 side is arranged. While FIG. 36 illustrates an example in which the claw fixing portions 3601 to 3606 are arranged at six locations, in the example illustrated in FIG. 42, claw fixing portions 4201 to 4205 are arranged at five locations which are one location less. Note, however, that a fixing claw having the finger hook portion is applied to one claw fixing portion 4201 indicated by a solid square, and a fixing claw not having the finger hook portion is applied to the four claw fixing portions 4202 to 4205 indicated by broken squares. Similarly to the example illustrated in FIG. 36, the fixing claw having the finger hook portion is applied only to the range where the R of the elliptical ear pad 107 is small, but only one location is provided. In a case where the demand for acoustic sealing (or passive noise canceling function in NC region) by the ear pad 107 is low, it is allowed to reduce the number of locations to which the fixing claw having the finger hook portion is applied.

Regarding the replaceable claw ear pad structure described in this section E-2, main features and effects thereof will be summarized.

(1) In the claw fixing type ear pad, a finger hook portion is formed at a position of the fixing claw facing the inner peripheral side of the ear pad. By hooking the fingertip on the finger hook portion and pressing the finger hook portion, the engagement relationship between the fixing claw and the housing side is released, and the ear pad can be easily removed.

(2) By dispersedly arranging the plurality of claw fixing portions along the elliptical contour of the ear pad, the ear pad can be more firmly fixed to the acoustic surface on the housing side, and acoustic sealing (or passive noise canceling function by ear pad) can be secured.

(3) By arranging the fixing claw having the finger hook portion among the plurality of claw fixing portions in the range where the curvature radius R is small, the entire ear pad can be warped when removing the ear pad, and the operation of removing the remaining fixing claw not having the finger hook portion becomes easy.

(4) By arranging the fixing claw having the finger hook portion at the front of the face so as not to come into contact with the ear, it is possible to prevent adverse influence on the wearing feeling.

### F. Wiring Portion Sealing Structure

As illustrated in FIG. 6, the housing 101 of the headphones 100 to which the present disclosure is applied is divided into a plurality of spaces in the case. Referring to FIG. 6 in detail, the side surface case 501 supports the diaphragm 601, and the front surface acoustic space 611 is formed on the front surface side of the diaphragm 601 and the first back surface space 612 is formed on the back surface side of the diaphragm 601 with the diaphragm 601 as a boundary. Furthermore, in the top surface case 502, the second back surface space 614 further on the back surface side than the first back surface space 612 is formed, and the printed wiring board 602 on which the electronic components including the drive circuit of the diaphragm 601 are mounted is arranged in the second back surface space 614. Therefore, on the wall separating the front surface acoustic space 611 and the second back surface space 614, a wiring portion 603 including a hole for inserting a cable for electrically connecting the diaphragm 601 and the printed wiring board 602 is provided. In short, in a case where a plurality of electric components are arranged in a case partitioned into a plurality of spaces while being dispersed in two or more spaces, a wiring portion having a through-hole for inserting a cable is required for a wall separating the spaces.

The wiring that electrically connects the diaphragm 601 and the printed wiring board 602 includes a cable having a flat cross-sectional shape such as a flexible flat cable (FFC) or a flexible printed circuit (FPC). Then, in order to ensure the acoustic performance of each space, the wiring portion 603 through which this type of cable is inserted is strongly required to be acoustically sealed, in other words, to have a minute and constant airflow volume.

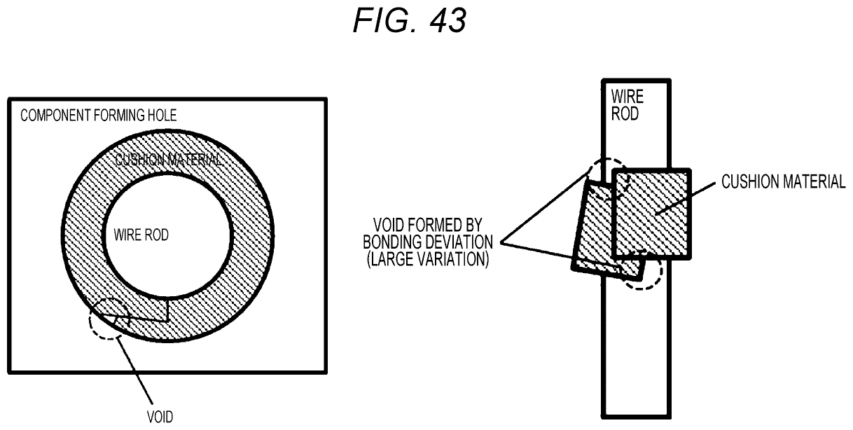

For example, a method is known in which when a cable is passed through a component forming a hole, a cushion material is sandwiched between the hole and the cable to ensure the sealability. The left side of FIG. 43 illustrates a state in which a hole through which a wire rod with a cushion material wrapped therearound passes is viewed from above. In addition, the right side of FIG. 43 illustrates a state in which a side surface of the wire rod with the cushion material wrapped therearound is viewed. In FIG. 43, portions of the cushion material are indicated by hatching. However, in such a method, variations are large due to the work of wrapping the cushion material, and the airflow volume is not constant. Furthermore, voids are likely to be generated in a portion where the cushion materials are bonded together (see left side in FIG. 43), and voids may be generated due to bonding deviation (see right side in FIG. 43).

Furthermore, a flexible wiring board in which a waterproof member for sealing a through hole is integrally molded by insert molding has been proposed (see Patent Document 6), but a structure near the through hole is enlarged.

Additionally, a method of closing the void between the through hole and the wire rod by bond coating or the like is also exemplified, but there are problems of enlargement of the structure and contamination of peripheral components due to bond adhesion.

Therefore, in the present disclosure, an insertion type bushing (or joining part) that presses the wire rod such as an FFC or an FPC against a wall surface of the through hole is used to close the void between the through hole and the wire rod in the wiring portion. Thus, according to the present disclosure, it is possible to achieve a stable acoustic space in the wiring portion and to achieve downsizing of the wiring portion or the sealed portion with the minimum component (bushing) and the minimum structure volume.

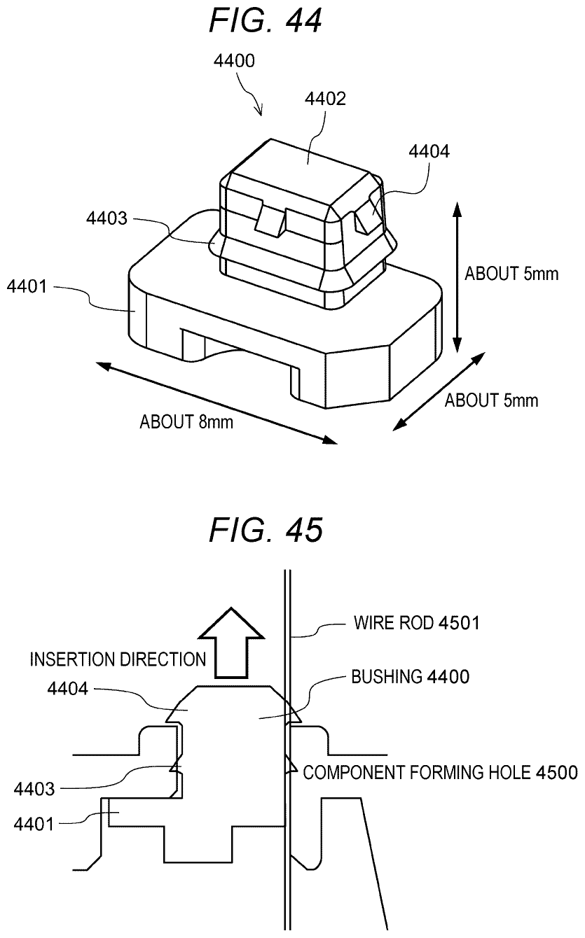

FIG. 44 illustrates an external configuration example of a bushing 4400 according to the present disclosure. The illustrated bushing 4400 includes a flat pedestal portion 4401 having a large contour, and a rectangular parallelepiped projection 4402 protruding in the insertion direction from the upper surface of the pedestal portion 4401. While FIG. 44 illustrates dimensions of about 5 mm×about 8 mm on the bottom surface and about 5 mm in thickness, these are design values that vary depending on the dimension of the through hole of the wiring portion 603 to which the bushing 4400 is applied. On the other hand, the cross-sectional shape of the projection 4402 is substantially the same as the shape of the through hole to which the bushing 4400 is applied. A sealing rib 4403 is formed substantially at the center of each of the four side surfaces of the projection 4402 over the entire circumference of the projection 4402. Furthermore, a fall prevention hook 4404 is formed at least at one location of an edge of an upper end surface of the projection 4402 (hooks 4404 are visible at two locations in FIG. 44). Furthermore, the flat pedestal portion 4401 has a recessed shape (not visible in FIG. 44) for facilitating grasping of the component on the opposite side (or side opposite to insertion direction) of the projection 4402.

The bushing 4400 is made of an elastic material such as silicon or elastomer. The hardness of the bushing 4400 is, for example, SHUR 80 degrees. More preferably, the surface of the bushing 4400 is provided with a lubricating coating in order to prevent getting stuck at the time of incorporation (at time of insertion into through hole of wiring portion 603).

FIG. 45 is a cross-sectional view taken along the insertion direction, illustrating a state in which the bushing 4400 illustrated in FIG. 44 is inserted into the component 4500 forming the hole. Specifically, the component 4500 forming the hole is the wiring portion 603 drilled in a wall surface partitioning the first back surface space 612 and the second back surface space 614. The bushing 4400 is inserted from bottom to top as indicated by an arrow in FIG. 45 into the component 4500 forming a hole through which a wire rod 4501 including FFC, FPC, or the like is inserted in advance.

Since the bushing 4400 has the pedestal portion 4401 larger than the hole, as can be seen from FIG. 45, the bushing is inserted to a depth at which the pedestal portion 4401 reaches the hole. In addition, since the bushing 4400 has the hooks 4404 at two or more locations on the edge portion of the upper end surface, once the bushing is completely inserted into the component 4500 forming the hole, the hook 4404 is caught by a back end portion of the hole, and thus, the bushing 4400 can be prevented from falling off. Then, in a state where the bushing 4400 is inserted into the component 4500 forming the hole, the wire rod 4501 is pressed against the wall surface of the hole by the side surface of the bushing 4400.

In addition, when the bushing 4400 is inserted into the hole, the sealing rib 4403 formed on the side surface of the projection 4402 over the entire circumference interferes with the wall surface of the hole and is pressed against the wall surface of the hole while being deformed, whereby the sealability is secured. As can be seen from the cross-sectional view of FIG. 45, the sealing rib 4403 has a cross-sectional shape whose distal end has an acute angle and is along the wall surface of the hole. The sealing rib 4403 has, for example, a height of about 0.5 mm and an interference amount with the hole of about 0.2 mm. Therefore, in the sealing rib 4403, since the main body of the bushing 4400 and the bushing 4400 are made of an elastic material such as silicon or elastomer, if the interference amount is about 0.2 mm, deformation to such an extent that the bushing 4400 can be inserted into the hole is allowed.

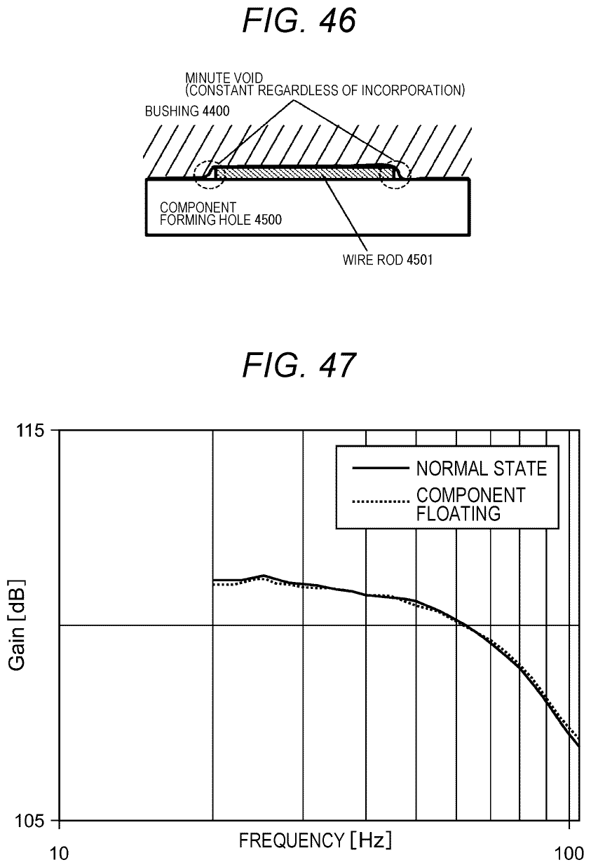

FIG. 46 is a cross-sectional view orthogonal to the insertion direction (or length direction of wire rod 4501) illustrating a state in which the bushing 4400 illustrated in FIG. 44 is inserted into the component 4500 forming the hole. The bushing 4400 is made of an elastic material such as silicon or elastomer, and is inserted into the hole and deformed to close the void between the hole and the wire rod 4501. As illustrated in FIG. 46, although voids are generated at both ends of the wire rod 4501, the airflow volume of the voids is minute and is constant regardless of the incorporation of the bushing 4400. Therefore, with the method of closing the through hole of the wiring portion 603 using the bushing 4400 according to the present disclosure, acoustic design with stable sound insulation performance is possible.

FIG. 47 illustrates comparison of frequency characteristics of the headphones 100 between a state (normal state) in which the bushing 4400 is normally attached to the wiring portion 603 and a state (with partial floating) in which the bushing 4400 is intentionally attached so as to be partially floated by about 0.5 mm. It can be seen from FIG. 47 that the frequency characteristics hardly change even if the incorporated state of the bushing 4400 is changed, that is, a stable sound insulation performance can be obtained by the method for sealing the wiring portion using the bushing 4400 according to the present disclosure.

In the configuration example illustrated in FIG. 6, the wiring portion 603 is provided only at one location on the wall surface partitioning the first back surface space 612 and the second back surface space 614, and is the only insertion place of the bushing 4400. Note, however, that the installation place of the wiring portion is not limited to one location illustrated in FIG. 6, and the application place of the wiring portion through which the wire rod is inserted, that is, the bushing, can be arranged at a plurality of locations in the case of the housing 101. Moreover, although FIG. 45 illustrates an example in which the bushing 4400 is inserted upward from below, the insertion direction of the bushing is not limited to one direction.

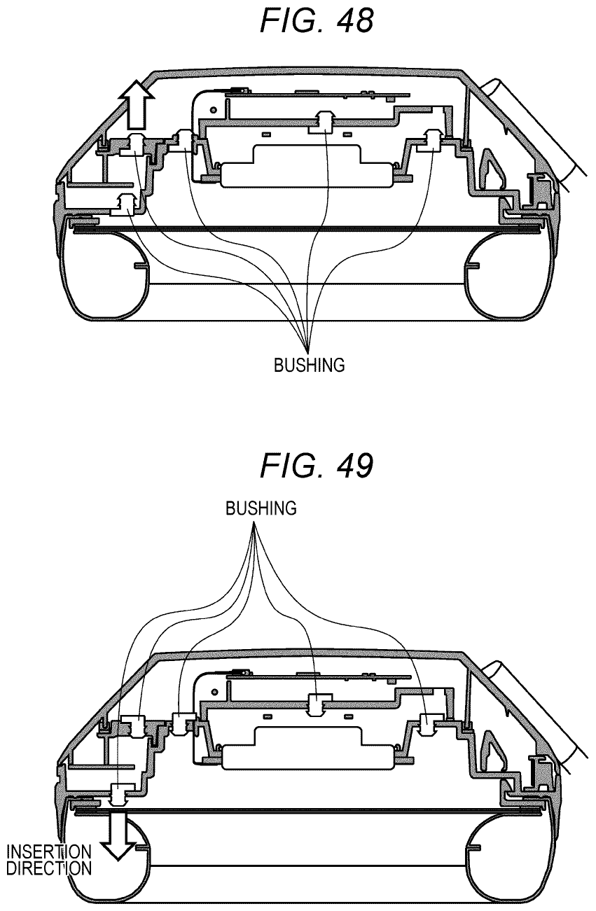

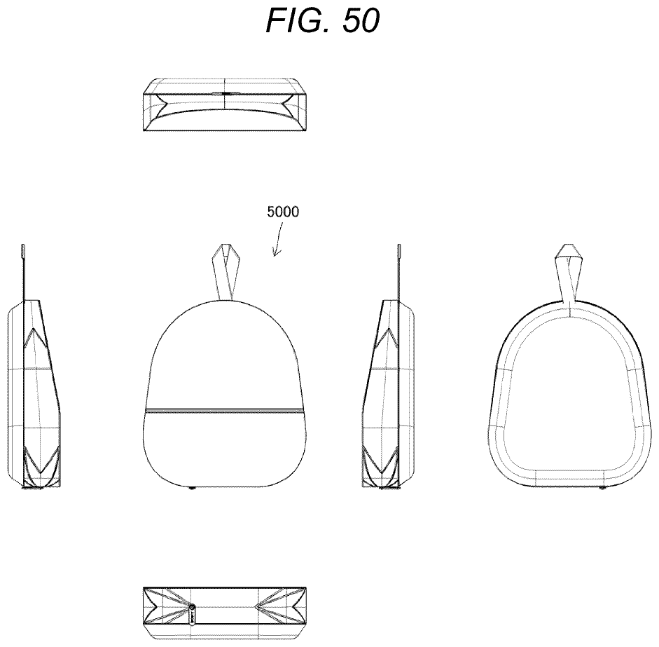

FIGS. 48 and 49 illustrate a modification of the arrangement place of the wiring portion (or place where bushing is applied) in the case of the housing 101. Note, however, that FIG. 48 illustrates a modification in a case where the insertion direction of the bushing is from bottom to top, and FIG. 49 illustrates a modification in a case where the insertion direction of the bushing is from top to bottom. In addition, although FIGS. 48 and 49 illustrate the candidate places of the plurality of wiring portions, how many places are actually used is a design matter. Additionally, the insertion directions of the plurality of bushings do not need to be unified, and the bottom to top direction and the top to bottom direction may be mixed.

Regarding the wiring portion sealing structure described in this section F, main features and effects thereof will be summarized.

(1) By inserting the bushing into the wiring portion between the spaces and closing the through hole while pressing the wire rod against the wall surface of the through hole, acoustic sealing can be achieved with minimum components and minimum structures. Since the minute void generated between the wire rod and the bushing is constant regardless of the incorporation of the bushing, acoustic design with stable sound insulation performance is possible.

(2) According to the configuration in which the bushing is inserted to seal the void of the wiring portion through which the wire rod is inserted, the bushing is easily inserted and removed, and manufacturability and reworkability are high.

(3) According to the configuration in which the bushing is inserted into the wiring portion between the spaces to close the through hole while pressing the wire rod against the wall surface of the through hole, it is not necessary to apply stress load, heat, and chemical influence to the wire rod.

### G. Carrying Case

A carrying case for headphones is often used to facilitate carrying of the headphones and to store the headphones and prevent damage due to external force at the time of storage.

In a hard carrying case, the carrying case itself is required to have high rigidity in order to protect the headphones from external force and impact. Therefore, the size and thickness of the carrying case do not change regardless of whether the headphones are stored. When the carrying case not storing the headphones is put into a bag or the like or is put away in a drawer, the carrying case becomes unnecessarily bulky.

Therefore, the present disclosure proposes a carrying case for headphones that can maintain high rigidity for protecting the headphones from external force and impact when storing the headphones, and can reduce the volume when not storing the headphones so as not to be bulky when the headphones are put into a bag or put into a drawer.

Note that the carrying case described in this section G is basically assumed to store the headphones 100 of the present embodiment (or illustrated in FIG. 1), but of course, the present disclosure can also be applied to a carrying case that stores other overhead headphones.

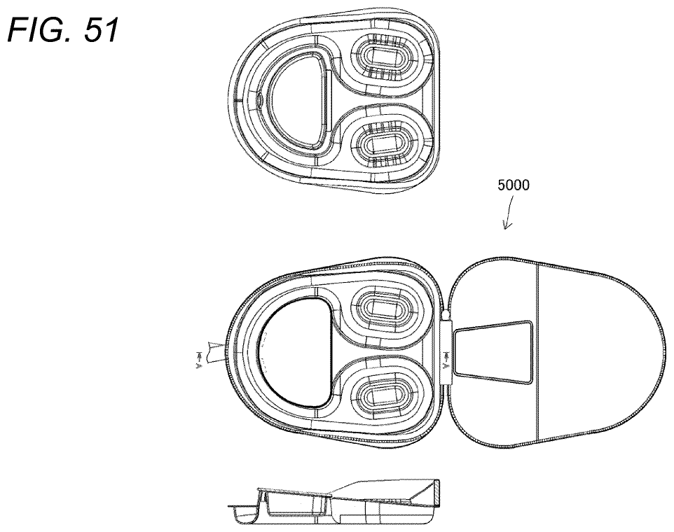

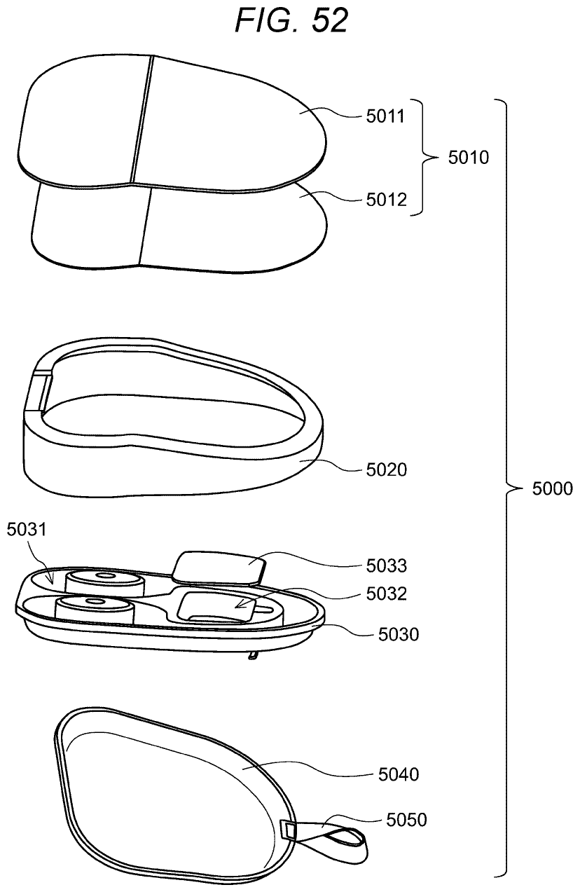

FIGS. 50 and 51 illustrate an example of a carrying case 5000 to which the present disclosure is applied. Note, however, that FIG. 50 illustrates a six-view diagram of the appearance of the carrying case 5000 as viewed from each of the upper, lower, front, rear, left, and right sides. In addition, FIG. 51 illustrates a two-view diagram in which the openable carrying case 5000 is opened as viewed from above and from one side surface. In addition, FIG. 52 is an exploded view of the carrying case 5000 disassembled into its main components.

Main components of the carrying case 5000 will be described with reference to FIG. 52. The carrying case 5000 includes a top surface lid portion 5010, a side surface portion 5020, an internal tray portion 5030, and a bottom surface tray portion 5040 in this order from the top. A strap 5050 is coupled to the distal end side of the bottom surface tray portion 5040.

The top surface lid portion 5010 includes a top surface lid front portion 5011 including plate-shaped polycarbonate and a top surface lid back portion 5012 obtained by bonding a raised fabric to thin plate-shaped polycarbonate. After cutting each of the top surface lid front portion 5011 and the top surface lid back portion 5012 into a predetermined contour shape, the top surface lid front portion 5011 and the top surface lid back portion 5012 are bonded to each other, grooving is performed by thermocompression bonding, and then edge folding is performed to obtain the top surface lid portion 5010 having a shape bent in a mountain fold near the center as illustrated in FIG. 52. The top surface lid portion 5010 has high rigidity to such an extent that it is not deformed even when an external force such as being crushed by a hand from above is applied, for example, and can protect the headphones 100 stored inside.

The internal tray portion 5030 mainly includes a material obtained by bonding a polyethyleneterephthalate (PET) resin material to a raised fabric, and a headphone storage pocket 5031 and an accessory storage pocket 5032 are formed by crimp molding. The headphone storage pocket 5031 includes a recess having substantially the same shape as the contour of the headphones 100, and holds the headphones 100 in a swiveled state (left and right housings 101 are rotated so as to be accommodated in substantially the same plane as headband 102 by twist function of slider 104). Additionally, the accessory storage pocket 5032 is a recess for storing accessory components formed at a place corresponding to the inside of the headband 102 of the headphones 100. Moreover, the internal tray portion 5032 may further include an accessory pocket lid 5033.

The bottom surface tray portion 5040 mainly includes a PET resin material, cut into a predetermined contour shape, and then molded into a container shape capable of accommodating the internal tray portion 5030 to be completed. Additionally, the strap 5050 is attached to the distal end side of the bottom surface tray portion 5040. Similarly to the top surface lid portion 5010, the bottom surface tray portion 5040 has high rigidity to such an extent that it is not deformed even when an external force such as being crushed by a hand from above is applied, for example, and can protect the headphones 100 housed inside.

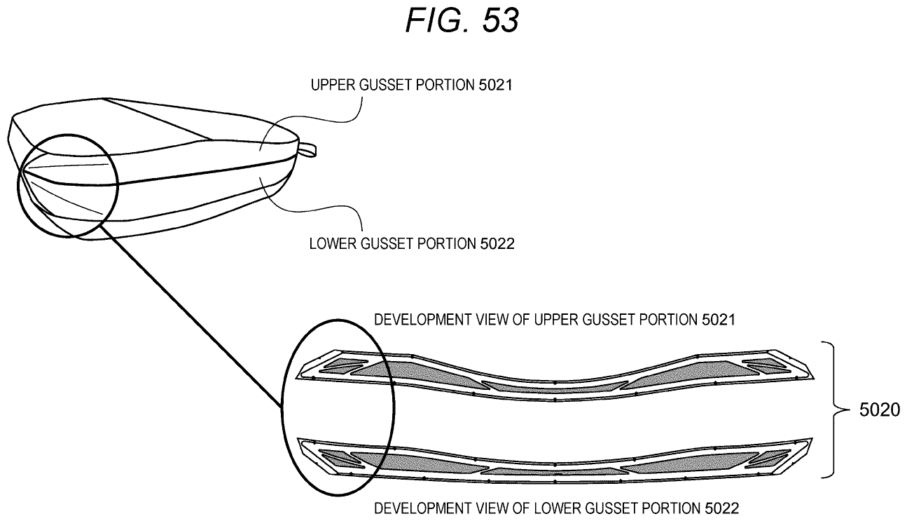

The side surface portion 5020 is drawn in FIG. 52 in a relatively simple one ring shape, but includes an upper gusset portion 5021 and a lower gusset portion 5022 which are upper and lower parts divided by a fastener (not illustrated in FIG. 52). FIG. 53 illustrates a developed view of the upper gusset portion 5021 and the lower gusset portion 5022. Each of the upper gusset portion 5021 and the lower gusset portion 5022 includes a soft front cloth and back cloth, and a hard core material bonded to the front cloth. The development view illustrated in FIG. 53 illustrates a state in which a core material is bonded to each of the front cloths of the upper gusset portion 5021 and the lower gusset portion 5022.

For each of the upper gusset portion 5021 and the lower gusset portion 5022, the front cloth and the core material are cut into predetermined contour shapes, and then the front cloth and the core material are bonded together and sewn into a link shape, and a fastener fabric is further sewn. Moreover, the back fabric is also cut into a predetermined contour shape and then sewn into a ring shape, and the fastener fabric is further sewn to complete the side surface portion 5020.

The side surface portion 5020 has different rigidity between a hard region (region colored in gray in each gusset portion in FIG. 53) including the core material and a soft region (white region of each gusset portion in FIG. 53) without the core material. Of the upper gusset portion 5021 and the lower gusset portion 5022, the region to which the highly rigid core material is bonded is hardly bent. Therefore, in the upper gusset portion 5021 and the lower gusset portion 5022, while the shape of the hard region including the core material is maintained, the soft region without the core material is deformed as a hinge, that is, a fold, and the side surface portion 5020 can be folded.

While the manufacturing process for each component of the carrying case 5000 has been described, the manufacturing process for assembling each component will also be described. First, the side surface portion 5020 and the bottom surface tray portion 5040 are sewn, and the strap 5050 is further attached to the bottom surface tray portion 5040. Next, the top surface lid back portion 5012 and the side surface portion 5020 are sewn, the top surface lid back portion 5012 and the top surface lid front portion 5011 are bonded, and finally, the internal tray portion 5030 is attached to complete the carrying case 5000.

Next, an operation of reducing the volume of the carrying case 5000 when not storing so as not to be bulky will be described.

As described above, the side surface portion 5020 has a hard region including a highly rigid core material and a hinge region without the core material, and the upper gusset portion 5021 and the lower gusset portion 5022 can be deformed with the hinge region without the core material serving as a fold while maintaining the shape of the hard region including the core material. In addition, a ring-shaped fastener region that joins the upper gusset portion 5021 and the lower gusset portion 5022 is also a hinge region that does not include a core material, and is a valley fold extending in the circumferential direction when the side surface portion 5020 is deformed. Then, the side surface portion 5020 can be folded by being bent such that a part of the hinge region not including the core material is valley folded and at least a part of the remaining hinge region not including the core material is mountain folded. For example, as a result of folding the side surface portion 5020 when the headphones 100 are not stored, the volume of the carrying case 5000 can be reduced so as not to be bulky.

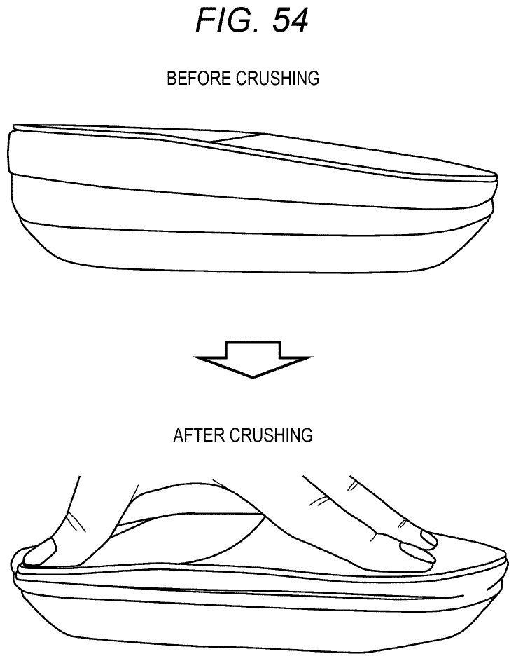

The upper part of FIG. 54 illustrates a state of the carrying case 5000 before the side surface portion 5020 is folded (or when headphones 100 are stored). In addition, the lower part of FIG. 54 illustrates a state in which the top surface lid portion 5010 is pressed by a human hand from above and the side surface portion 5020 is folded when the headphones 100 are not stored. As illustrated in the drawing, the side surface portion 5020 is folded downward by bending the ring-shaped fastener region joining the upper gusset portion 5021 and the lower gusset portion 5022 so as to be valley folded. As a result, since the thickness of the carrying case 5000 is reduced, the entire volume is reduced, and it is possible to prevent bulkiness.

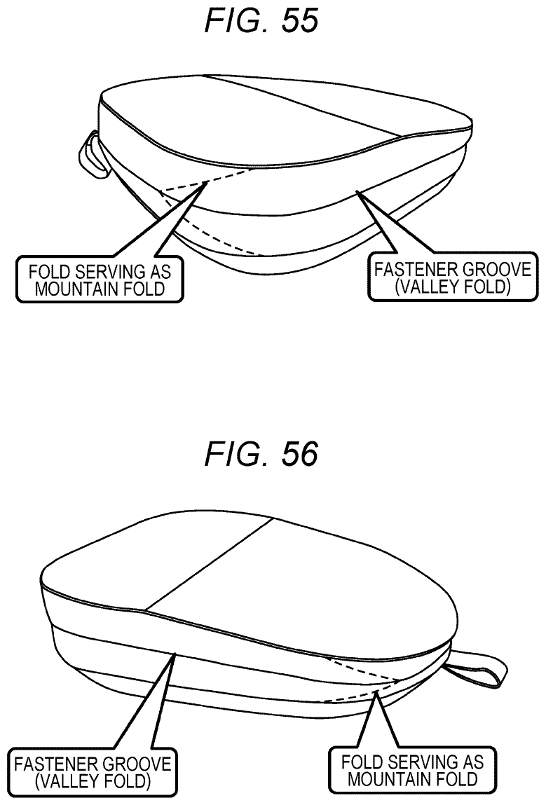

The folding structure is configured by arranging folds that are valley folds and mountain folds in the circumferential direction. When the side surface portion 5020 is folded in the headphones 100, as illustrated in FIG. 54, the hinge region having the fastener is valley folded, and at least a part of the remaining hinge region not including the core material is mountain folded. Parts of the side surface portion 5020 where folds serving as mountain folds are formed are illustrated with reference to FIGS. 55 and 56.

Regarding the wiring portion sealing structure described in this section G, main features and effects thereof will be summarized.

(1) The carrying case to which the present disclosure is applied is a hard type in which both the top surface lid portion and the bottom surface tray portion have high rigidity and the side surface portion also includes a hard core material, and the headphones can be protected from external force and impact when the headphones are stored. On the other hand, in the side surface portion, a fastener portion joining the upper side and the lower side and a portion not including the core material serve as a hinge region, and a part of the hinge region is bent in a valley fold and another part of the hinge region is bent in a mountain fold, so that the side surface portion is folded in the thickness direction and becomes thin. Therefore, the headphones when not in use are folded to be compact so as not to be bulky, and can be easily stored away in a bag or a drawer.

### INDUSTRIAL APPLICABILITY

The present disclosure has been described in detail with reference to the specific embodiments. However, it is obvious that those skilled in the art can make modifications and substitutions of the embodiment without departing from the gist of the present disclosure.

In the present specification, the embodiment in which the present disclosure is mainly applied to an overhead headphone including a noise canceling microphone has been mainly described, but the gist of the present disclosure is not limited thereto. For example, the structure of the slider described in the above section D, the ear pad structure described in the above section E, the wiring portion sealing structure described in the above section F, and the carrying case described in the above section G can be applied to a headphone not equipped with a microphone for noise canceling.

In short, the present disclosure has been described in an illustrative manner, and the contents disclosed in the present specification should not be interpreted in a limited manner. To determine the gist of the present disclosure, the claims should be taken into consideration.

Note that the present disclosure may also have the following configurations.

(1) Headphones including a headband, a housing, an ear pad attached to the housing, a hanger that supports the housing, and a slider that connects the hanger to an end portion of the headband, in which
the headphones further include a microphone arranged at a place of the housing outside a movable range of the hanger.

(1-1) The headphones according to (1), in which
the microphone is used to pick up an external sound for noise canceling.

(1-2) The headphones according to (1), in which
a case of the housing has a hole for the microphone.

(2) The headphones according to (1), in which
the housing includes a case that covers a movable range of the hanger.

(2-1) The headphones according to (2), in which
the case of the housing has a slit for operating a joint portion of the hanger with the head band.

(3) The headphones according to any one of (1) and (2), in which
the hanger and the microphone are arranged in the same space formed in the housing.

(3-1) The headphones according to (3), in which
the microphone is arranged on an outer peripheral side of the hanger.

(4) The headphones according to any one of (1) to (3), in which
the housing includes a diaphragm, and has one or more spaces different from a space in which the hanger and the microphone are arranged, on a side where the ear pad is far with the diaphragm as a boundary.

(5) The headphones according to any one of (1) to (4), in which
another one or more microphones are arranged in a space different from the hanger and the microphone in the housing.

(6) The headphones according to any one of (1) to (4), in which
the slider has a seamless short-arc hollow pipe shape, and contains a cable connected to a circuit in the housing in the hollow pipe.

(7) The headphones according to (6), in which
the slider includes a resin having a seamless short-arc hollow pipe shape, and a shaft twist slider including a metal nut component inserted into a joint portion between the resin and the hanger.

(7-1) The headphones according to (7), in which
the metal nut component is inserted into the resin by any one of thermal press-fitting, adhesion, molding insert, and ultrasonic press-fitting.

(8) The headphones according to (7), in which
the slider rotatably supports the hanger about a center line of the slider by a fastening structure of the metal nut component and a distal end of a shaft twist inserted into the hanger.

(9) The headphones according to any one of (7) and (8), in which
the metal nut component includes a protrusion that restricts a twist angle of the hanger.

(10) The headphones according to any one of (7) to (9), in which
the metal nut component has a slit to be fitted with the resin having a short-arc hollow pipe shape.

(11) The headphones according to any one of (7) to (10), in which
the slider has a cylindrical shape having the same diameter as the hanger, and is coaxially coupled with the hanger in a rotatable manner.

(12) The headphones according to any one of (1) to (11), in which
the ear pad is configured by containing a ring-shaped urethane foam in a skin, and
the skin is configured by bonding a thin urethane film integrated with at least one of a bottom surface or a front surface of a wet foam layer having a three-dimensional microporous structure to a base cloth.

(13) The headphones according to any one of (1) to (11), in which
the ear pad is configured by containing a ring-shaped urethane foam in a skin, and
the skin is configured by bonding a wet foam layer having a three-dimensional microporous structure to a front surface of a product obtained by bonding an air-impermeable moisture-permeable waterproof film to any one of a bottom surface and a front surface of a wet base cloth having open cells or air permeability.

(14) The headphones according to any one of (1) to (11), in which
the ear pad is configured by containing a ring-shaped urethane foam in a skin, and
the skin is configured by bonding a wet foam layer having a three-dimensional microporous structure to a front surface of a product obtained by bonding a dry layer to only one of a bottom surface and a front surface of a wet base cloth.

(15) The headphones according to any one of (1) to (11), in which
the ear pad is configured by containing a ring-shaped urethane foam in a skin, and
the skin is configured by bonding a wet foam layer having a dry layer bonded to both a front surface and a back surface of the wet foam layer to a front surface of a base cloth, or configured by bonding a wet foam layer and a wet base cloth having air permeability, any one of the wet foam layer and the wet base cloth containing an impregnated material.

(16) The headphones according to any one of (1) to (15), in which
the ear pad includes a fixing claw including a finger hook portion provided on an inner peripheral side of a ring shape.

(17) The headphones according to (16), in which
the fixing claw has a claw fitting structure with a claw fixing portion on the housing side.

(18) The headphones according to any one of (16) and (17), in which
the fixing claw includes a hinge that supports the finger hook portion, and when the finger hook portion is operated, the hinge is deformed and the fixing claw is released from the housing side.

(19) The headphones according to any one of (16) to (18), in which
the ear pad includes fixing claws arranged at a plurality of locations on an inner periphery.

(20) The headphones according to (19), in which
the fixing claws arranged at a plurality of locations include a fixing claw including a finger hook portion and a fixing claw not including a finger hook portion.

(21) The headphones according to (20), in which
the fixing claws including a finger hook portion are arranged side by side in a range where a curvature radius R of the ear pad is small.

(22) The headphones according to any one of (20) and (21), in which
the fixing claw including the finger hook portion is arranged at a front of a face.

(23) The headphones according to any one of (16) to (22), in which
the finger hook portion is arranged at a visible position.

(24) The headphones according to any one of (1) to (23), further including
a hole through which a wire rod is inserted into a wall that separates a space in the housing, and
a bushing inserted into the hole so as to press the wire rod against a wall surface of the hole.

(24-1) The headphones according to (24), in which
the bushing includes silicon, elastomer, or another material having elasticity.

(24-2) The headphones according to (24), in which
a surface of the bushing is provided with a lubricating coating.

(24-3) The headphones according to (24), in which
the hardness of the bushing is SHUR 80 degrees.

(25) The headphones according to (24), in which
the bushing has a rib formed over an entire circumference, and the rib interferes with a wall surface of the hole when the bushing is inserted into the hole.

(26) The headphones according to (25), in which
the rib has an acute distal end and has a shape along a wall surface of the hole.

(27) The headphones according to any one of (24) to (26), in which
the bushing includes a hook that is caught by a back end portion of the hole when the bushing is inserted into the hole.

(28) The headphones according to any one of (24) to (27), in which
the bushing includes a flat pedestal portion having a protrusion on a side opposite to an insertion direction.

(29) A carrying case for the headphones according to claim 1, including:
a top surface lid portion;
a bottom surface tray portion; and
a side surface portion having a ring shape sewn to the top surface lid portion and the bottom surface tray portion and having a fold that is folded by a pressing force in a vertical direction.

(30) The carrying case according to (29), in which
a valley fold and a mountain fold are arranged in a circumferential direction in the side surface portion, and the side surface portion is folded at the fold by a pressing force in a vertical direction to reduce a thickness.

(31) The carrying case according to any one of (29) and (30), in which
the side surface portion includes a hard portion configured by bonding a core material to a cloth and a soft portion including only the cloth, and the side surface portion is folded by using at least a part of the soft portion as a fold.

(32) The carrying case according to any one of (29) to (31), in which
the side surface portion includes a fastener, and an upper gusset portion and a lower gusset portion connected via the fastener, and the side surface portion is folded by using at least the fastener as a fold.

(33) The carrying case according to any one of (29) to (32), in which
the top surface lid portion has a shape bent in a mountain fold near a center.

(34) The carrying case according to any one of (29) to (33), further including
a strap.

(35) The carrying case according to any one of (29) to (34), further comprising
an internal tray portion accommodated in the bottom surface tray unit, and having a headphone storage pocket including a recess along a contour of the headphones according to claim 1.

### REFERENCE SIGNS LIST

100/5900 Headphones
101 Housing
102 Headband
103 Hanger
104 Slider
106 Speaker
107 Ear pad
302 FF microphone
303 FF cancellation signal generation unit
304 Reproduction unit
305 Synthesis unit
306 FB microphone
307 FB cancellation signal generation unit
501 Side surface case
502 Top surface case
601 Diaphragm
602 Printed wiring board
603 Wiring portion
604 Microphone
611 Front surface acoustic space
612 First back surface space
613 Outer peripheral space
614 Second back surface space
615 NC region
901 to 904 Microphone
1001 to 1004 Microphone
1101 to 1104 Microphone
1301 to 1304 Microphone
1501 Lid hanger
1502 Connection cable
1503 Shaft twist slider (metal nut component)
1504 Shaft twist
1505 O-ring
1601 Knurled portion
1602 Protrusion
5701 Recess
1603 Slit
5801 Projection
2001 Microphone hole
2301 Cushion material
2302 Film
2501 Base cloth
2502 Urethane film
2503 Wet foam layer
2601 Urethane film
2701, 2702 Urethane film
2801 Wet base cloth
2802 Moisture-permeable prevention film
2803 Wet foam layer
2901 Moisture-permeable prevention film
2902 Wet base cloth
2903 Wet foam layer
3001 Base cloth
3002 Wet foam layer
3003 Dry layer
3101 Dry layer
3102 Base cloth
3103 Wet foam layer
3104 Dry layer
3201 Base cloth
3202 Dry layer
3203 Wet foam layer
3204 Dry layer
3301 Wet base cloth
3302 Dry layer
3303 Wet foam layer
3304 Impregnated material
3501 Projection
3502 Hinge
3503 Finger hook portion
3511 Rib
3601 to 3606 Claw fixing portion
4001 Finger hook portion
4002 Projection
4011 Rib
4101 Finger hook portion
4102 Projection
4111 Rib
4201 to 4205 Claw fixing portion
4400 Bushing
4401 Pedestal portion
4402 Projection
4403 Sealing rib
4404 Hook
4500 Component forming hole
5000 Carrying case
5010 Top surface lid portion
5011 Top surface lid front portion
5012 Top surface lid back portion
5020 Side surface portion
5021 Upper gusset portion
5022 Lower gusset portion
5030 Internal tray portion
5031 Headphone storage pocket
5032 Accessory storage pocket
5033 Accessory pocket lid
5040 Bottom surface tray portion
5050 Strap

1. Headphones comprising
a headband, a housing, an ear pad attached to the housing, a hanger that supports the housing, and a slider that connects the hanger to an end portion of the headband, wherein
the headphones further comprise a microphone arranged at a place of the housing outside a movable range of the hanger.

2. The headphones according to claim 1, wherein
the housing includes a case that covers a movable range of the hanger.

3. The headphones according to claim 1, wherein
the hanger and the microphone are arranged in a same space formed in the housing.

4. The headphones according to claim 1, wherein
the housing includes a diaphragm, and has one or more spaces different from a space in which the hanger and the microphone are arranged, on a side where the ear pad is far with the diaphragm as a boundary.

5. The headphones according to claim 1, wherein
another one or more microphones are arranged in a space different from the hanger and the microphone in the housing.

6. The headphones according to claim 1, wherein
the slider has a seamless short-arc hollow pipe shape, and contains a cable connected to a circuit in the housing in the hollow pipe.

7. The headphones according to claim 6, wherein
the slider includes a resin having a seamless short-arc hollow pipe shape, and a shaft twist slider including a metal nut component inserted into a joint portion between the resin and the hanger.

8. The headphones according to claim 7, wherein
the slider rotatably supports the hanger about a center line of the slider by a fastening structure of the metal nut component and a distal end of a shaft twist inserted into the hanger.

9. The headphones according to claim 7, wherein
the metal nut component includes a protrusion that restricts a twist angle of the hanger.

10. The headphones according to claim 7, wherein
the metal nut component has a slit to be fitted with the resin having a short-arc hollow pipe shape.

11. The headphones according to claim 7, wherein
the slider has a cylindrical shape having a same diameter as the hanger, and is coaxially coupled with the hanger in a rotatable manner.

12. The headphones according to claim 1, wherein
the ear pad is configured by containing a ring-shaped urethane foam in a skin, and
the skin is configured by bonding a thin urethane film integrated with at least one of a bottom surface or a front surface of a wet foam layer having a three-dimensional microporous structure to a base cloth.

13. The headphones according to claim 1, wherein
the ear pad is configured by containing a ring-shaped urethane foam in a skin, and
the skin is configured by bonding a wet foam layer having a three-dimensional microporous structure to a front surface of a product obtained by bonding an air-impermeable moisture-permeable waterproof film to any one of a bottom surface and a front surface of a wet base cloth having open cells or air permeability.

14. The headphones according to claim 1, wherein
the ear pad is configured by containing a ring-shaped urethane foam in a skin, and
the skin is configured by bonding a wet foam layer having a three-dimensional microporous structure to a front surface of a product obtained by bonding a dry layer to only one of a bottom surface and a front surface of a wet base cloth.

15. The headphones according to claim 1, wherein
the ear pad is configured by containing a ring-shaped urethane foam in a skin, and
the skin is configured by bonding a wet foam layer having a dry layer bonded to both a front surface and a back surface of the wet foam layer to a front surface of a base cloth, or configured by bonding a wet foam layer and a wet base cloth having air permeability, any one of the wet foam layer and the wet base cloth containing an impregnated material.

16. The headphones according to claim 1, wherein
the ear pad includes a fixing claw including a finger hook portion provided on an inner peripheral side of a ring shape.

17. The headphones according to claim 16, wherein
the fixing claw has a claw fitting structure with a claw fixing portion on the housing side.

18. The headphones according to claim 16, wherein
the fixing claw includes a hinge that supports the finger hook portion, and when the finger hook portion is operated, the hinge is deformed and the fixing claw is released from the housing side.

19. The headphones according to claim 16, wherein
the ear pad includes fixing claws arranged at a plurality of locations on an inner periphery.

20. The headphones according to claim 19, wherein
the fixing claws arranged at a plurality of locations include a fixing claw including a finger hook portion and a fixing claw not including a finger hook portion.

21. The headphones according to claim 20, wherein
the fixing claws including a finger hook portion are arranged side by side in a range where a curvature radius R of the ear pad is small.

22. The headphones according to claim 20, wherein
the fixing claw including the finger hook portion is arranged at a front of a face.

23. The headphones according to claim 16, wherein
the finger hook portion is arranged at a visible position.

24. The headphones according to claim 1, further comprising
a hole through which a wire rod is inserted into a wall that separates a space in the housing, and
a bushing inserted into the hole so as to press the wire rod against a wall surface of the hole.

25. The headphones according to claim 24, wherein
the bushing has a rib formed over an entire circumference, and the rib interferes with a wall surface of the hole when the bushing is inserted into the hole.

26. The headphones according to claim 25, wherein
the rib has an acute distal end and has a shape along a wall surface of the hole.

27. The headphones according to claim 24, wherein
the bushing includes a hook that is caught by a back end portion of the hole when the bushing is inserted into the hole.

28. The headphones according to claim 24, wherein
the bushing includes a flat pedestal portion having a protrusion on a side opposite to an insertion direction.

29. A carrying case for the headphones according to claim 1, comprising:
a top surface lid portion;
a bottom surface tray portion; and
a side surface portion having a ring shape sewn to the top surface lid portion and the bottom surface tray portion and having a fold that is folded by a pressing force in a vertical direction.
